(19) United States
(12) Patent Application Publication
(10) Pub. No.: US 2023/0385634 A1
(43) Pub. Date: Nov. 30, 2023

(54) Neural Networks with Local Converging Inputs (NNLCI) for Solving Differential Equations

(71) Applicant: Georgia Tech Research Corporation, Atlanta, GA (US)

(72) Inventors: Yingjie Liu, Alpharetta, GA (US); Haoxiang Huang, Atlanta, GA (US); Vigor Yang, Atlanta, GA (US)

(21) Appl. No.: 18/196,127

(22) Filed: May 11, 2023

Related U.S. Application Data
(60) Provisional application No. 63/341,123, filed on May 12, 2022.

(51) Int. Cl. G06N 3/08; G06F 17/13

(52) U.S. Cl. CPC G06N 3/08; G06F 17/13

(57) ABSTRACT

An exemplary system and method using a deep neural network to predict the high-fidelity solutions of a system of differential equations is disclosed. The deep neural network requires input of at least two parts from two or more approximate solutions, each taken from low-cost numerical models that converge toward the exact solution of the differential equations. Each of the parts of the input is a local space-time patch of the corresponding low-cost numerical solution. The neural network predicts high-fidelity solutions to the system of equations as part of the exemplary method and is implemented in the exemplary system.

### RELATED APPLICATIONS

This U.S. patent application claims priority to, and the benefit of, U.S. provisional application, U.S. 63/341,123, filed on May 12, 2022, entitled “Neural Networks with Local Converging Inputs (NNLCI) for Solving Differential Equations,” which is hereby incorporated by reference herein in its entirety.

### STATEMENT OF GOVERNMENT SUPPORT

This invention was made with government support under Grant No. DMS-1522585 awarded by the National Science Foundation. The government has certain rights in the invention.

### BACKGROUND

Many real-world problems can be expressed by one or more differential equations, e.g., for vehicle design, structure design, antenna design, financial market predictions, predicting the variations of strips on a zebrafish, or any problem addressing the flow of gases, liquids, electrons, or electromagnetic waves. In industrial design workflows, there is a benefit to developing and optimizing several dozen to several hundred model variations; however, the amount of computational and real-world time spent on these endeavors could range from months to years. There are real-world implications and benefits to decreasing the computational cost of solving a differential equation.

Solving differential equations can be extremely demanding of computational resources. When modeling of differential equations is necessary, numerical methods of approximation are often used, which can range in complexity, computational demand, and accuracy. The approximations are used in lieu of directly solving a differential equation.

Whole fields of study are directed to designing numerical models, often referred to as optimizers, that excel in the speed of computation, the accuracy of the result, or complexity of the allowed inputs. Depending on the objective of the real-world problem, an appropriate numerical model can be found. Where numerical models fail in accuracy is correctly predicting discontinuities, such as step discontinuities, which may be seen as shock waves in a graph, or local or global maxima, such as the peak of a graph. Numerical solutions to design models often lack the accuracy to be consistently useful in optimizing real-world designs.

As the development of machine learning models, such as neural networks, has progressed, these tools have also been applied to predicting solutions of differential equations. The application of machine learning or artificial intelligence models has been varied and oftentimes highly specific to the design problem at hand.

### SUMMARY

The exemplary system and method are disclosed that use a neural network, in commercial or proprietary simulation software, to predict the high-fidelity solution of a system of differential equations in a given space-time domain using local converging inputs consisting of two or more parts, each taken from low-cost numerical solutions to the equations, to predict highly accurate and computationally inexpensive solutions to a multitude of design problems.

The term “local converging inputs,” as used herein, refers to a special design of the input to the neural network. The low-cost numerical solutions are taken in a manner that results in a sequence of solutions that converge toward the exact solution of the differential equations. Each of the two parts of the input is a local space-time patch of the corresponding low-cost numerical solution, and the space-time locations of the patch cover the domain of dependence of the solution at the space-time location where the prediction is to be made.

The term “differential equations,” as used herein, refers to one or more unknown functions and their derivatives or partial derivatives for a single or multivariable function. In applications, the functions generally represent physical quantities, the derivatives represent their rates of change, and the differential equation defines a relationship between the two.

The exemplary system and method can provide a highly accurate solution in the smooth or non-smooth region of the space-time domain of concern. This is a breakthrough because it can be difficult to use the existing neural network-based schemes to directly and accurately predict the solution of a system of partial differential equations that may contain multiple discontinuities and their ensuing interactions. The exemplary system and method is straightforward to implement to produce high fidelity results. It can be applied to essentially all kinds of differential equations. Further, the computing cost is minimal, so the new method is especially well suited for repetitive simulations. It offers a wide spectrum of applications in scientific research and engineering applications.

In some embodiments, the exemplary system and method provide a tool for substantially reducing the computational cost, in commercial or proprietary simulation software, of a large number of repetitive calculations, such as design optimization of a complex engineering system. For example, to optimize a car shape, the exemplary system could be directed to first analyze a small number of shapes by executing high-fidelity simulations for the aerodynamics around those shapes together with two low-cost simulations and then using the calculated results to train a neural network. The exemplary system can then use the trained neural network to execute for all remaining possible shapes. The low-cost simulation results are then used as inputs to the trained neural network to predict the corresponding high-fidelity results. Finally, an optimal shape can be selected from the neural network predictions without the formidable cost of running high-fidelity simulations for all possible shapes.

Indeed, the exemplary system and method can be used effectively and efficiently for a wide variety of scientific and engineering problems that repetitively require high-fidelity, large-scale solutions of differential equations. Examples include aircraft shape optimization, engine design, antenna design, building and structure design, battery optimization, and many other industrial design and optimization problems. The exemplary system and method can either be used by itself or incorporated into commercial software.

The exemplary system and method can additionally be used to reduce the cost of repetitive large-scale simulations that are based on either reduced-order modeling (in particular projection-based ROM) or neural networks with straightforward inputs. All of these methods fail to handle problems involving rapid changes of state in the space-time domain of concern, such as shock waves, contact discontinuities, thermodynamic phase transitions, and material disparity. The exemplary system and method circumvent this challenge and can capture discontinuities effectively and efficiently. It is especially suitable for high-fidelity solutions with fine resolution.

In some embodiments, the trained neural network may be implemented in dedicated hardware, e.g., AI chips.

A study was conducted that demonstrated that the exemplary system and method can function effectively and efficiently for gas-dynamics problems, among other engineering and scientific problems described herein. In the study, the exemplary system and method were capable of capturing shock waves and contact discontinuities with a resolution even sharper than existing numerical schemes.

In an aspect, a method is disclosed comprising, in a simulation software, (a) receiving, in an analysis engine of the simulation software, two numerical models (e.g., used in engineering model, financial model, etc.) for one or more differential equations (e.g., for a system of partial differential equations) to be evaluated by the simulation software, including a first numerical model and a second numerical model (with a different grid size), wherein the two or more numerical models are converging to an exact solution of the system of differential equations; (b) generating, by the analysis engine, from the first numerical model, a first numerical solution (e.g., array of solution values, first part of input of a neural network) in a first grid patch in which the first grid patch corresponds to a local domain of dependence, and, wherein the first grid patch has a first grid resolution; (c) generating, by the analysis engine, from the second numerical model, a second numerical solution (e.g., array of solution values, second part of input of the neural network) in a second grid patch in which the second grid patch corresponds to the local domain of dependence, wherein the second grid patch has a second resolution that is different (e.g., coarser of finer) from the first grid patch; and (d) generating a high-fidelity numerical solution value at a space-time location determined by the local domain of dependence for the system of partial differential equations using the trained neural network with its input generated in steps (b) and (c), and repeating steps (b) and (c) to provide as input to determine respective high-fidelity numerical solution values for one or more iteratively varying local domains of dependence, wherein a neural network is trained on one or more design iteration analyses of the plurality of design iteration analyses, wherein each of the one or more design iteration analyses includes (i) an exact or nearly exact solution to the system of differential equations for the design iteration analysis and (ii) solutions to the two or more numerical models for the design iteration analysis.

The term “local domain of dependence,” as used herein, refers to, for a partial differential equation, a small portion of a range such that the solution values on this portion determine the solution at a given space-time location.

In some embodiments, the neural network training comprises computing the difference between (i) the output of the neural network and (ii) the exact or nearly exact solution for use in a loss function.

In some embodiments, the method further includes repeating steps (b), (c), and (d) for an additional design iteration analysis of the plurality of design iteration analyses.

In some embodiments, the method further includes interpolating outputs of the two or more numerical models to align to common grid points of the first and second grid patches.

In some embodiments, the plurality of design iteration analyses correspond to an engineering model, scientific model, or financial model (e.g., mechanical engine design, airfoil, antenna design, aircraft and/or car shape optimized design), wherein the two or more numerical models are used by the trained neural network to generate high-fidelity solutions for an additional design iteration analysis of the plurality of design iteration analyses.

In some embodiments, the trained neural network is part of a neural network engine, the neural network engine comprising logic or instructions to direct steps (a)-(d).

In some embodiments, the neural network engine is executing on a cloud infrastructure.

In some embodiments, the neural network engine is executing on a computing device executing the analysis engine.

In another aspect, a system (e.g., analysis system) is disclosed comprising one or more processors; and a memory having instructions stored thereon, wherein the instructions, as part of a simulation software, when executed by a processor, cause the processor to perform the steps: (a) receive, in an analysis engine of the simulation software, two numerical models (e.g., used in engineering model, financial model, etc.) for one or more differential equations (e.g., for a system of partial differential equations) to be analyzed or evaluated by the simulation software, including a first numerical model and a second numerical model (with a different grid size),, wherein the two or more numerical models are converging to an exact solution of the system of differential equations; (b) generate, by the analysis engine, from the first numerical model, a first numerical solution (e.g., array of solutions, output) in a first grid patch in which the first grid patch corresponds to a local domain of dependence, and, wherein the first grid patch has a first grid resolution (output domain); (c) generate, by the analysis engine, from the second numerical model, a second numerical solution (e.g., array of solutions) in a second grid patch in which the second grid patch corresponds to the local domain of dependence, wherein the second grid patch has a second resolution that is different (e.g., coarser of finer) from the first grid patch (e.g., wherein outputs of the first numerical solution and of the second numerical solution have the same length); and (d) generate a high-fidelity numerical solution value at a space-time location determined by the local domain of dependence for the system of partial differential equations using the trained neural network with its input generated in steps (b) and (c), and repeat steps (b) and (c) to provide as input to determine respective high-fidelity numerical solution values for one or more iteratively varying local domains of dependence, wherein a neural network is trained on one or more design iteration analyses of the plurality of design iteration analyses, wherein each of the one or more design iteration analyses includes (i) an exact or nearly exact solution to the system of differential equations for the design iteration analysis and (ii) solutions to the two or more numerical models for the design iteration analysis.

In some embodiments, the instructions further comprise the step: repeat steps (b), (c), and (d) for an additional design iteration analysis of the plurality of design iteration analyses.

In some embodiments, the plurality of design iteration analyses corresponds to an engineering model, scientific model, or financial model (e.g., mechanical engine design, airfoil, antenna design, aircraft and/or car shape optimized design), wherein the two or more numerical models are used by the trained neural network to generate high-fidelity solutions for an additional design iteration analysis of the plurality of design iteration analyses.

In some embodiments, the trained neural network is a part of a neural network engine, the neural network engine comprising logic or instructions to direct steps (a)-(d).

In some embodiments, the neural network engine is executed on a processor in a cloud infrastructure.

In some embodiments, the neural network engine and analysis engine are executed on one or more processors in a computing device.

In another aspect, a non-transitory computer-readable medium is disclosed having instructions stored thereon, wherein the instructions, when executed by a processor, cause the processor to perform the steps: (a) receive, in an analysis engine of a simulation software, two numerical models (e.g., used in engineering model, financial model, etc.) for one or more differential equations (e.g., for a systems of partial differential equations) to be analyzed or evaluated by the simulation software, including a first numerical model and a second numerical model (with a different grid size), wherein the two or more numerical models are converging to an exact solution of the system of differential equations; (b) generate, by the analysis engine, from the first numerical model, a first numerical solution (e.g., array of solutions, output) in a first grid patch in which the first grid patch corresponds to a local domain of dependence, and, wherein the first grid patch has a first grid resolution (output domain); (c) generate, by the analysis engine, from the second numerical model, a second numerical solution (e.g., array of solutions) in a second grid patch in which the second grid patch corresponds to the local domain of dependence, wherein the second grid patch has a second resolution that is different (e.g., coarser of finer) from the first grid patch (e.g., wherein outputs of the first numerical solution and of the second numerical solution have the same length); and (d) generate a high-fidelity numerical solution value at a space-time location determined by the local domain of dependence for the system of partial differential equations using the trained neural network with its input generated in steps (b) and (c), and repeat steps (b) and (c) to provide as input to determine respective high-fidelity numerical solution values for one or more iteratively varying local domains of dependence, wherein a neural network is trained on one or more design iteration analyses of the plurality of design iteration analyses, wherein each of the one or more design iteration analyses includes (i) an exact or nearly exact solution to the system of differential equations for the design iteration analysis and (ii) solutions to the two or more numerical models for the design iteration analysis.

In some embodiments, the instructions further comprise the step: repeat steps (b), (c), and (d) for an additional design iteration analysis of the plurality of design iteration analyses.

In some embodiments, the plurality of design iteration analyses corresponds to an engineering model, scientific model, or financial model (e.g., mechanical engine design, airfoil, antenna design, aircraft and/or car shape optimized design), wherein the two or more numerical models are used by the trained neural network to generate high-fidelity solutions for an additional design iteration analysis of the plurality of design iteration analyses.

In some embodiments, the trained neural network is a part of a neural network engine, the neural network engine comprising logic or instructions to direct steps (a)-(d).

In some embodiments, the neural network engine is implemented in a library file that can be coupled to the analysis engine.

In some embodiments, the neural network engine is natively implemented in a simulation software comprising the analysis engine.

### BRIEF DESCRIPTION OF DRAWINGS

The skilled person in the art will understand that the drawings described below are for illustration purposes only.

FIG. 1A shows a schematic of the exemplary system implemented in a host (cloud server, PC, etc.) in an exemplary engineering modeling pipeline.

FIG. 1B shows a schematic of the exemplary system implemented in simulation software in an exemplary engineering modeling pipeline.

FIG. 2 shows a schematic of the training of the neural network.

FIG. 3 shows a schematic of the calculation of the Loss function during training.

FIG. 4A shows a schematic of the logic in the neural network engine.

FIG. 4B shows a schematic of the logic in the neural network engine repeated over a plurality of design data.

FIG. 5 shows a representation of the first and second numerical model solutions on a first and second grid patch for a local domain of dependence and related input to the neural network engine.

FIG. 6 shows an example of local low-cost numerical solutions of a function containing a shock wave and a steep, smooth function.

FIG. 7 shows an example of smeared numerical discontinuity under mesh refinement.

FIG. 8 shows an example of a smeared numerical smooth wave under mesh refinement.

FIGS. 9A-9F shows 2CGNN predictions of density profiles at final-time (t=0.16) solution of Lax problem (dark blue) (FIGS. 9A-9C) and Sod problem (dark blue) (FIGS. 9D-F), low-fidelity input solutions (blue and red) by leapfrog and diffusion splitting scheme of equation 6 on two different grids (with 50 and 100 cells, respectively), and “exact” (reference) solution (green): (FIGS. 9A, 9D) input type of equation 5, (FIGS. 9B-9C) input with 2 intermediate time steps, (FIGS. 9C, 9F) input type of equation 4.

FIG. 10 shows the 2DCNN prediction of the final-time (t=0.159888) solution of the Lax problem (dark blue), low-fidelity input solutions (blue and red) by the Leapfrog and diffusion splitting scheme on the uniform grid with 100 cells, with diffusion coefficient α=Δx and 4Δx respectively, and “exact” (reference) solution (green).

FIGS. 11A-11F shows 2CGNN predictions of final-time (t=0.038) solution of the Woodward-Colella problem (dark blue) (FIGS. 11A-11C) and with +5% perturbation blast waves, low-fidelity input solutions (blue and red) by a 3d order finite volume method on two different grids (with 200 and 400 cells resp.), and “exact” (reference) solution (green): (FIGS. 11A, 11D) density, (FIGS. 11B, 11E) pressure, (FIGS. 11C, 11F) velocity.

FIGS. 12A-12F shows 2DCNN prediction of the final-time (t=0.038) solution of the Woodward-Colella problem (dark blue) (FIGS. 12A-12C) and of the blast waves with its initial value being +5% perturbation of that of the Woodward-Colella problem (FIGS. 12D-12F), low-fidelity input solutions (blue and red) by the Rusanov scheme and a 3d order finite volume method respectively on the same grid (with 400 cells), and “exact” (reference) solution (green): (FIGS. 12A, 12D) density, (FIGS. 12B, 12E) pressure, (FIGS. 12C, 12F) velocity.

FIG. 13 shows 2CGNN predictions of the final-time (t=0.3) solution of Configuration 6 (a) and with an initial value +5% perturbation of that of Configuration 6 (b).

FIGS. 14A-14F shows the Density cross-section profiles (along (FIGS. 14A, 14D) y=0.34, (FIGS. 14B, 14E) y=0.50, (FIGS. 14C, 14F) y=0.60 of the 2CGNN prediction of the final-time (t=0.3) solution of Configuration 6 predicted density (dark blue), (FIGS. 14A-14C) and with initial value +5% perturbation of that of Configuration 6 (FIGS. 14D-14F), low-fidelity input solutions (blue and red) by leapfrog and diffusion splitting scheme on 200×200 and 400×400 grids respectively, and “exact” (reference) solution (green).

FIGS. 15A-15D shows 2CGNN prediction of (FIG. 15A) the final-time (t=0.25) density solution of Configuration 8 with initial value +5% perturbation (FIG. 15C), and (FIGS. 15B, 15D) the respective cross-section profile (dark blue) along y=0.60, compared to low-fidelity input solutions (blue and red) by leapfrog and diffusion splitting scheme on 200×200 and 400×400 grids, respectively, and “exact” (reference) solution (green).

FIG. 16 shows a system diagram where the neural network engine is implemented on a computing device.

### DETAILED SPECIFICATION

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the nth reference in the list. All references cited and discussed in this specification are incorporated herein by reference in their entireties and to the same extent as if each reference was individually incorporated by reference.

### EXAMPLE SYSTEMS

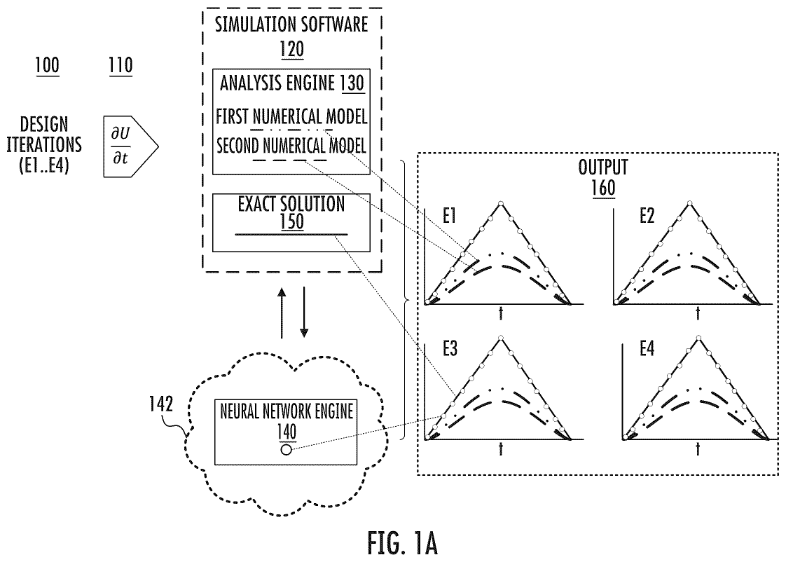

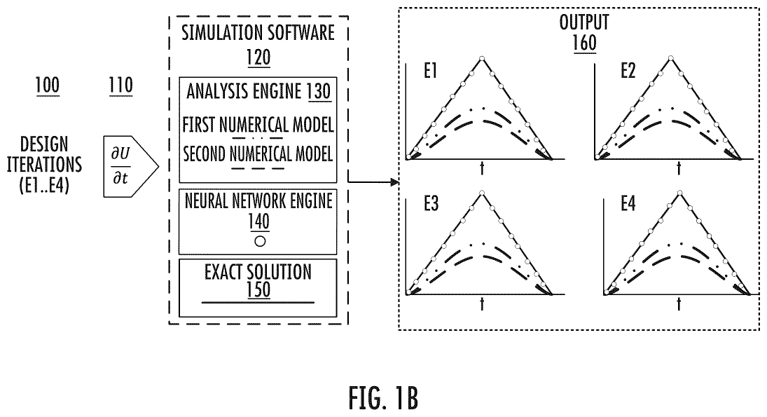

FIG. 1A shows an exemplary system 100 comprising a neural network engine 140 implemented in a cloud-computing environment 142 that communicates, over a network, with simulation software 120 executing on a local computing device 122. The neural network engine 140 is configured to generate a set of high-fidelity solution 144 (shown as 144a, 144b, 144c, etc.) for each set of a number of desired design iterations 102 using a set of low-cost numerical models (shown as 146, 148) computed by the simulation software 120. While the high-fidelity solution 144 produced by the neural network engine 140 could be numerically computed by the simulation software 120, the neural network engine 140 can provide the solutions more efficiently and more quickly—e.g., reducing the computation time and resources by 100 folds.

In the example shown in FIG. 1A, the simulation software 120 is configured to receive a set of design iterations 102 from a design library 104. The design library 104 may be a data store such as a local storage device or a network storage device. The design iterations 102 may be or include a set of industrially applicable constraints, boundary conditions, or input variables that are described by one or more differential equations 110. The simulation software 120, via its modeler 106 and solver 108, is configured to compute low-cost numerical models to generate approximate solutions to a set of differential equations. The modeler 106 and solver 108 include all necessary logic and instructions, e.g., for a solver, to solve the numerical models and provide input to the neural network engine. The term “approximate solutions” refers to a lower-fidelity numerical solution than the high-fidelity solutions 144 or 150. The choice of appropriate numerical models can be varied based on the design prediction and would be understood by one skilled in the art.

The simulation software 120 is configured to additionally compute the exact or nearly exact solution 150 for a subset of the design iterations. The solution 150 and the first numerical and second numerical model are then provided to the cloud-computing environment 142 in the training of the neural network. Once trained, the simulation software 120 may evaluate the other design iterations by providing low-cost numerical models of the other design iterations to the trained neural network to generate high-fidelity solutions for them. The trained neural network thus serves as a solver accelerator for the solver 108, but one that implements the solution for the system of differential equations from a pattern-classification approach rather than through a numerical approach.

As shown in FIG. 1A, the analysis system 130, via the modeler 106 and solver 108, receives or generates a first and second numerical model 146, 148 from the one or more differential equations 110 associated with a design iteration 102 (shown as “E1” 152). The modeler 106 and solver 108 generate the output 152, as training data, which includes the exact or near exact solution 150 and the two numerical models 146 and 148 and their associated solutions.

Once trained, the modeler 106 and solver 108 can provide similar low-cost numerical models that are locally converging to the trained neural network to generate high-fidelity predictions 144a, 144b, 144c (shown as open dots in the output graphs) for the other design iterations for the neural network (shown as design iteration equation set “E2”, design iteration equation set “E3”, and design iteration equation set “E4”). The solutions of the first and second models 146, 148 (dashed lines in the output graphs), as provided by the simulation software 120, must converge to the exact solution of the differential equations, previously referred to as local converging input. In one example, the first and second numerical models are solved using different numerical optimizers for solving the differential equations. In another example, the first and second numerical models are solved using the same numerical optimizers solved to varying degrees of accuracy, such as solving the numerical optimizers with relatively larger or smaller step sizes.

FIG. 1B shows another implementation of the neural network engine 140. In FIG. 1, the neural network is implemented as a part of the simulation software 120. In some embodiments, the neural network engine 140 is implemented as a library file or a software module that can operate with the modeler 106 and solver 108.

### Example Neural Network Engine

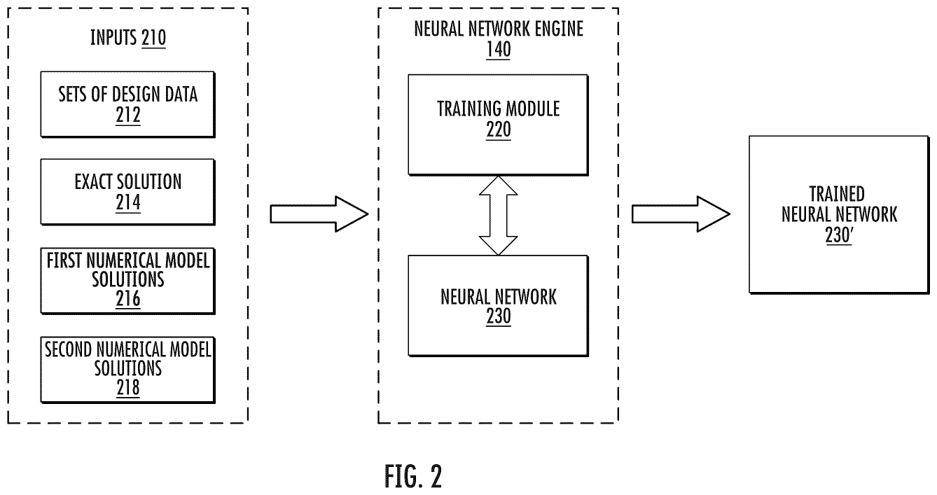

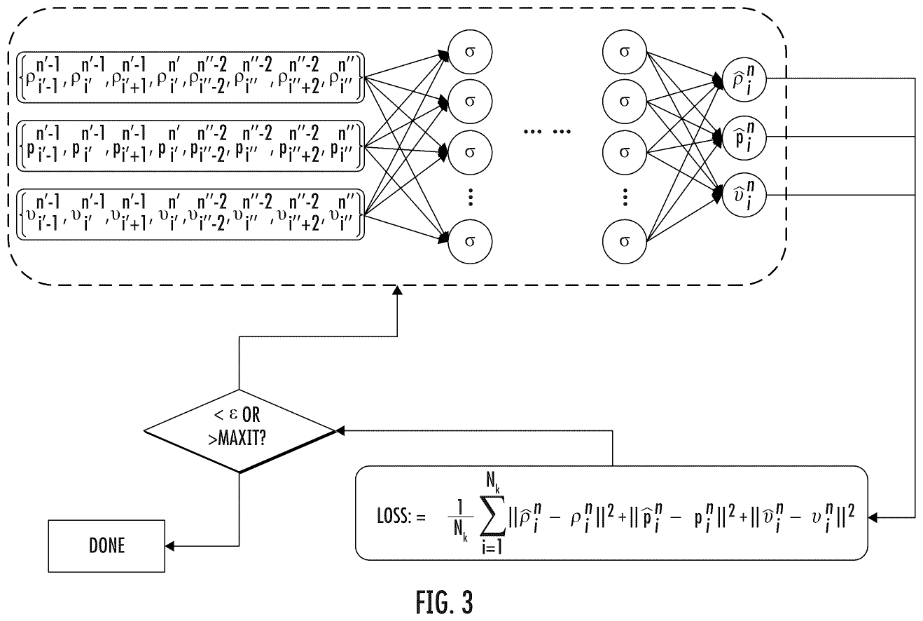

FIGS. 2 and 3 show an example of the neural network engine. As shown in FIG. 2, the neural network engine can operate with a training module 220. The neural network engine 140 receives inputs 210 comprising sets of design data 212, exact or nearly exact solutions 214, and solutions to the first and second numerical models (216, 218), respectively. The inputs are used in the training of the neural network to produce a trained neural network (230′).

FIG. 3 shows an example of the neural network and associated training. Solutions to the first and second numerical model 302 for a set of design data are input {p, p, v} to the neural network 230′, then the neural network processes the input over a number of nodes, a, and layers, and outputs predictive values of {p, P, 6} for the set of design data. The output of the neural network, {p, P, 6}, is compared to the exact solution for the set of design data and a loss value 304 is computed. The training module 220 executes the logic to optimize the weights of the neural network 230′ based on the computed loss values 304. Further discussion and selection of the logic in the training module may be considered from the state of the art.

Other machine learning or artificial intelligence operations may be used according to the methods described herein to predict the high-fidelity solution of a system of differential equations in a given space-time domain using local converging inputs. A generative adversarial network (GAN) may be used.

Machine Learning. The term “artificial intelligence” can include any technique that enables one or more computing devices or comping systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

Machine learning models include supervised, semi-supervised, and unsupervised learning models. In a supervised learning model, the model learns a function that maps an input (also known as feature or features) to an output (also known as target or target) during training with a labeled data set (or dataset). In an unsupervised learning model, the model a pattern in the data. In a semi-supervised model, the model learns a function that maps an input (also known as feature or features) to an output (also known as a target) during training with both labeled and unlabeled data.

Neural Networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as an input layer, an output layer, and optionally one or more hidden layers. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanH, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similar to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of the cost function can be used. LR classifiers are known in the art and are therefore not described in further detail herein.

An Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is a supervised classification model that classifies new data points based on similarity measures (e.g., distance functions). The k-NN classifiers are trained with a data set (also referred to herein as a “dataset”) to maximize or minimize a measure of the k-NN classifier's performance during training. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

### Example Method of Operation

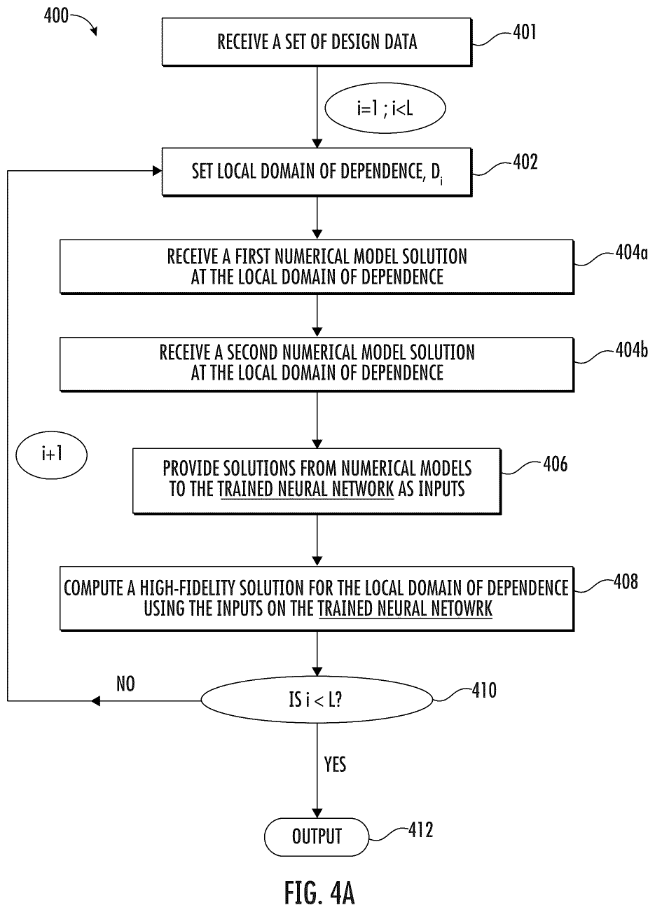

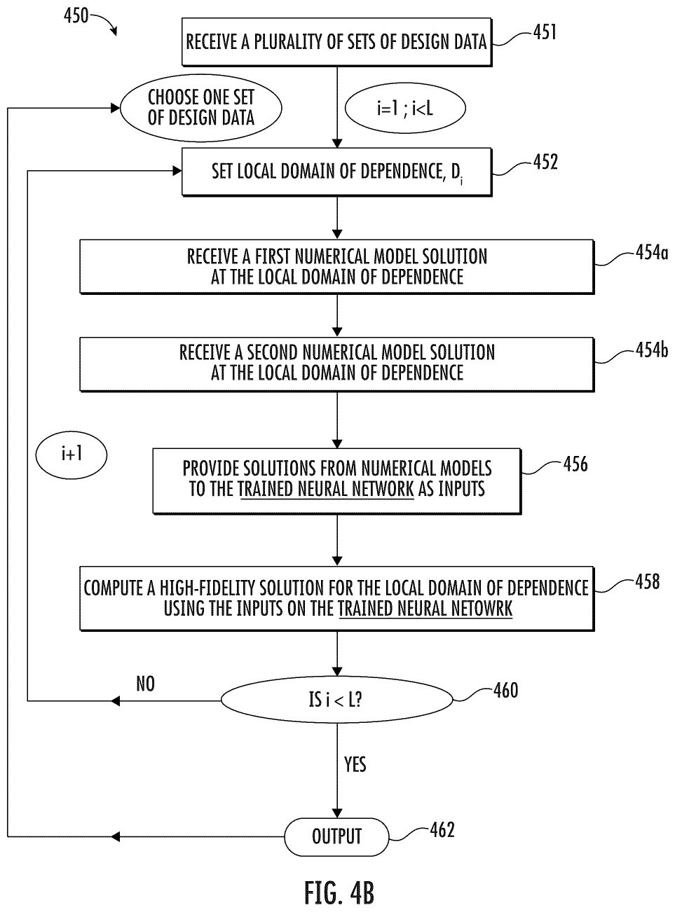

FIG. 4A shows an example AI deep neural network method 400 of operation to generate high-fidelity solutions to a system of differential equations based on inputs from low-cost numerical solutions of the system for a set of design data (e.g., a design or a model). The method 400 includes the neural network engine receiving (401) a set of design data, which may be a set of industrially applicable constraints, boundary conditions, or input variables.

The method 400 then includes evaluating two or more numerical models of the system of differential equations on a grid defined by a local domain of dependence (e.g. x, y, t) such that the two or more numerical models each produce output data objects of identical length, wherein the resolution of the grid for each of the two or more numerical models is progressively coarser or finer, and the output of the two or more numerical models are converging to an exact solution of the system of differential equations in the local domain of dependence.

In some embodiments, the method 400 includes setting (402) a local domain of dependence, Di, (402), which is a discrete patch (1<i<L), where L represents the space-time location which may be one, two, three or more dimensions. For example, given a space-time location (x, t) (x if the system of differential equations is time-independent, t if it is a dynamical system, similarly to the remaining), the method includes choosing a local domain of dependence D of (x, t) for the system of differential equations. The exemplary neural network is designed to predict the high-fidelity solution of the system of differential equations at (x, t).

For a local domain of dependence, the neural network engine then receives (404a, 404b) a first numerical model solution and a second numerical model solution. The first and second numerical model solutions are low-cost numerical models that can be computed to approximate solutions of the system of differential equations. The system of differential equations may be one or more differential equations. The two approximate solutions must be in a sequence converging to the exact solution of the system of differential equations. The input to the neural network includes (at least) two parts, ideally with an equal number of elements in each part. One part is formed through the patch of approximate solution in D computed by one low-cost numerical model; the other part is similarly computed by the other low-cost numerical model but with a finer or coarser numerical resolution. The nth element (n=1, 2, . . . ) in one part of the input corresponds to the same space-time location in D, as does the nth element in the other part. The loss function used in training of the neural network may be, e.g., the mean squared error between the predicted solution of the neural network and a known high-fidelity solution.

Method 400 then includes providing (406) the first and second numerical model solutions to the trained neural network as inputs, and the trained neural network is configured to compute (408) a high-fidelity solution for the local domain of dependence.

The steps of setting a local domain of dependence, receiving the first and second numerical model solutions, providing the said solutions as input, and computing high-fidelity solutions using the trained neural network may then be repeated (411) for all local patches (i) over a space-time location (1<i<L) (410). The high-fidelity solutions at all local domains of dependence are then output (412) for the predicted solutions for the set of design data.

The output of the two or more numerical models may be interpolated onto a rectangular grid. The method may also further comprise repeating the preceding steps for one or more analyses of the set of analyses (e.g., designs). In this embodiment, the neural network is trained using an exact or nearly exact solution to the system of differential equations and solutions to the two or more numerical models of the system of differential equations for a subset of the set of analyses.

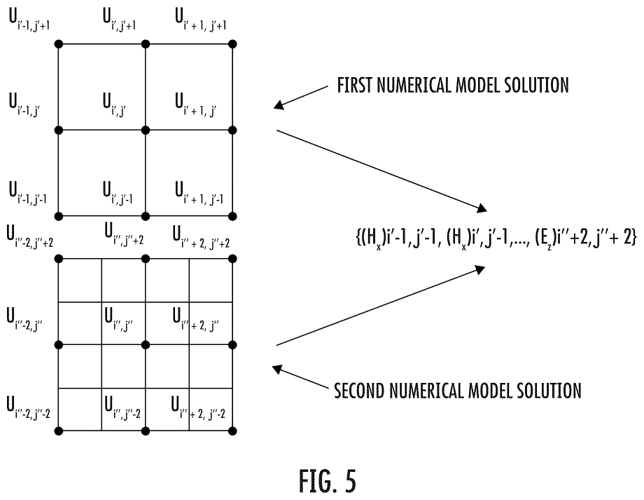

In an example of the method 400, FIG. 5 depicts the scheme for solving the first and second numerical models at a local domain of dependence. For each numerical model, the solutions are computed on defined grids that are bound by the local domain of dependence and which have defined grid resolutions, (i′, f′) for the grid of the first numerical model and (i″, j″) for the grid of the second numerical model wherein the resolution of the second grid patch is finer than the first grid patch and wherein the solutions of the first and second numerical model converge to the exact solution. In the present example, the first and second numerical models are the same, U([[©]]i, j). The solutions of the first and second numerical models differ by the grid resolution used to compute the solutions, and the solutions have the same number of solutions at the same locations within the local domain of dependence. The output from the solutions to the first and second numerical models, {Hₓ(i‘j’), Eₓ(i‘j’)} and {H_{z}(i″j″), Eₓ(i″j″)}, respectively, are then concatenated for use in the neural network.

In another example, the first and second numerical models are defined by different mathematical model equations, for instance, U(©, j) and U′(i′, j′), and the solutions are computed on defined grids that are bound by the local domain of dependence, and which have defined grid resolutions, (i′, f′) for the grid of first numerical model and (i″, j″) for the grid of the second numerical model wherein the resolution of the second grid patch is finer than the first grid patch and wherein the solutions of the first and second numerical model converge to the exact solution. The solutions of the first and second numerical models differ by the grid resolution used to compute the solutions, and the solutions have the same number of solutions at the same locations within the local domain of dependence.

In yet another example, three or more numerical models are defined by the same or different mathematical model equations, U(©, j), U′(i′, j′), U″(© ″, j″), . . . U″(i″, j″), and the solutions are computed on defined grids which are bound by the local domain of dependence, and which have defined grid resolutions, (i′, f′) for the grid of first numerical model and (i″, j″) for the grid of the second numerical model wherein the resolution of each grid is finer than the previous grid and wherein the solutions of the first and second numerical model converge to the exact solution. The solutions of the first and second numerical model differ by the grid resolution used to compute the solutions, and the solutions have the same number of solutions at the same locations within the local domain of dependence.

FIG. 4B shows another schematic of the logic in the neural network engine of FIG. 4A, repeated over a plurality of design data. In FIG. 4B, a plurality of design data are received (451). A design of the plurality can be selected and evaluated per the operations described in relation to FIG. 4A. Then, the output operation can be re-performed (462) for each of the design set. In this manner, the system can perform additional design iteration analyses of the plurality of design iteration analyses.

### Experimental Results and Additional Examples

A study was conducted that evaluated several systems of differential equations.

### Example #1 Euler equations in 1-D Problems

In one study, PDE functional forms were given to the exemplary neural network (e.g., FIG. 3) using 1^{st}-order numerical schemes, including the Rusanov scheme, Leapfrog scheme with diffusion terms, and Leapfrog scheme with diffusion terms and operator splitting to approximate the solution.

In this study, a 1-D conservation law was used for the exemplary methods. A scalar conservation law was defined per Equation 1.

$$\frac{\partial U}{\partial t} + \frac{\partial f ( U )}{\partial x} = 0 , x ∈ Ω ⊂ ℛ , t ∈ [ 0 , T ] . \qquad ( 1 )$$

The 1-D Euler equations for an ideal gas were used per Equation 2.

$$\frac{\partial }{\partial t} ( \begin{matrix}ρ \\ ρ v \\ E\end{matrix} ) + \frac{\partial }{\partial x} ( \begin{matrix}ρ v \\ ρ {v}^{2} + p \\ v ( E + p )\end{matrix} ) = 0 , x ∈ Ω ⊂ ℛ , t ∈ [ 0 , T ] , \qquad ( 2 )$$

where p, u and p were density, velocity and pressure, respectively, and Ω=[a, b] was an interval, per Equation 3.

$$E = \frac{p}{γ - 1} + \frac{1}{2} ρ {v}^{2} . \qquad ( 3 )$$

Equation 3 defined the specific heat ratio, and its value was 1.4 throughout the instant study.

Variant of 2-Coarse grid NN for the Euler equations. In the study, a neural network using two coarse-grid solutions (2CGNN) was defined as follows. Let [a, b] be partitioned with a coarse uniform grid α=x₀<x₁< . . . <x_{M}=b having spatial grid size Δx=x₁−x₀ and let the time step size be Δt. The grid was refined to obtain a finer uniform grid with spatial grid size ½Δx and time step size ½Δt. Let L be a low-cost scheme used to compute (1) on both grids. Given a grid point xᵢ′ at time tₙ′ (on the coarsest uniform grid) where the solution was predicted by a neural network, the coarsest grid solution (computed by L) was chosen at 3 points x_{i′-1}, xᵢ′ and x_{i′+1} at time level t_{n′-1} and also at point (x_{i′}, t_{n′}) as the first part of the input, and the finer grid solution (also computed by L) at the same space-time locations as the second part of input.

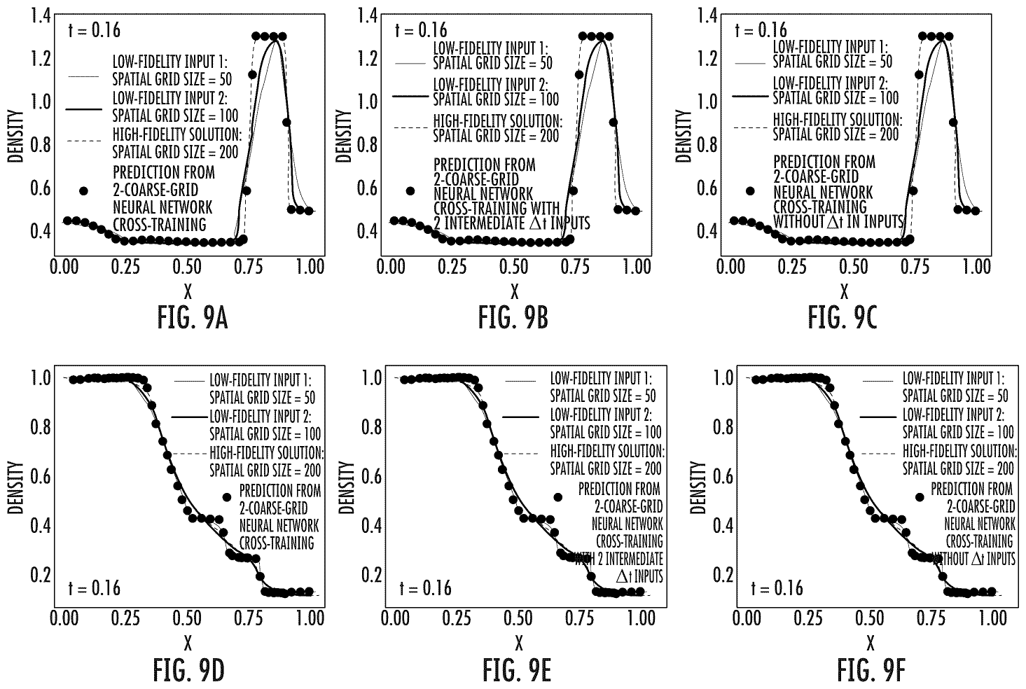

FIG. 9A shows the input grid scheme. The chosen 4 space-time locations of either grid enclosed a local (space-time) domain of dependence of the exact solution at (x_{i′}, t_{n′}) in which the full domain of dependence contained the physical domain of dependence. Since the two parts of the input solution had different levels of approximation to the exact or reference solution, the neural network utilized the information to extrapolate a prediction of the exact or reference solution. The first part of the input was denoted as u_{i′-1}^{n′-1}, u_{i′-1}^{n′}, u_{i′-1}^{n′+1}, u_{i′}^{n′}, and the second part of the input as u_{i″-2}^{n″-2}, u_{i″}^{n″-2}, u_{i″+2}^{n″-2}, u_{i″}^{n″}.

The space-time index (i′, f′) in the coarsest grid refers to the same location as (i″, n″) does in the finer grid, (i′−1, n′−1) refers to the same location as (i″−2, n″−2) does, and so on. In the case study, where the predicted solution was sought at (x, t), which is referred to as (i′, n′) in the coarsest grid, the input of 2CGNN was defined per Equation 4.

{u_{i′-1}^{n′-1},u_{i′-1}^{n′},u_{i′-1}^{n′+1},u_{i′}^{n′},u_{i″-2}^{n″-2},u_{i″}^{n″-2},u_{i″+2}^{n″-2},u_{i″}^{n″}} (4)

Equation 4 is called “input of u,” and the corresponding output of 2CGNN was the predicted solution at (x, t). For the Euler system (2), the input and output of 2CGNN were made up of the corresponding ones for each prime variable. For example, if the input is the vector {input of p, the input of v, the input of p} with 8×3=24 elements, the corresponding output will be {p, v, p} at (x, t) with 3 elements.

The loss function measured the difference between the output and the reference solution corresponding to the input and was defined as follows:

Loss=Σₖ∥(output corresponding to k^{th} set of input)−(reference solution corresponding to k^{th} set of input)∥₂²

where ∥·∥₂ being the 2-norm, and the summation went through every set of input in the training data. Training using the Loss function is schematically presented in FIG. 4A.

Cross-training and Incorporating the Time Step Size into the Input. In another example, Δt was fixed as the size of the time step of the low-cost scheme used in computing inputs on the coarsest grid. To account for training processes that require different time step sizes, the time step size Δt was incorporated as part of the input. The modified input for Equation 1 is defined per Equation 5, and the output is unchanged.

{u_{i′-1}^{n′-1},u_{i′-1}^{n′},u_{i′-1}^{n′+1},u_{i′}^{n′},u_{i″-2}^{n″-2},u_{i″}^{n″-2},u_{i″+2}^{n″-2},u_{i″}^{n″},Δt} (5)

Similarly, the input for the Euler system (Equation 2) included Δt, and the output remained unchanged. Incorporating the time step size into the input allowed the low-cost scheme to use various time step sizes in computing inputs for the training data and in computing inputs for the neural network to make predictions.

The associated neural network for 2CGNN in this evaluation included 6 hidden layers, and each layer had 180 neurons. When performing “cross-training” (i.e., the training data covers several different problems, such as the Lax and Sod problems), the neural network included 6 hidden layers with 255 neurons per layer, or even 300 neurons per layer. When Δt was chosen to be the same in the Lax and Sod problems, there was no need to treat Δt as part of the input. The neural network structure to predict the final time of Lax and Sod problems consisted of 5 hidden layers with 66 neurons per layer.

During the training process, the neural network minimized the difference between the outputs of the neural network and a reference solution by using an Adam optimizer first and an L-BFGS optimizer thereafter in TensorFLow (with the number of iterations of optimization procedure under 50000 each.) After completing the training, the neural network was used to predict a solution (different from the training data), given an input computed by the same low-cost scheme(s) and grids, which were used to compute inputs of the training data. The trained neural network was used to predict final solutions for 14 initial values of the Euler system which include the original initial values of the Lax and Sod problems and ±3%, ±5%, and ±7% perturbations of their initial values.

In order to generate the training data, a first-order scheme was used on the coarsest uniform grid (50 cells) and the finer uniform grid (100 cells) to compute the input data from several initial values of the Euler system, which include ±2%, ±4%, ±6%, ±8% and ±10% perturbations of the initial values of the Lax and Sod problems. The high-resolution reference solutions of the training data are computed by a higher order scheme on a uniform grid with 200 cells. This scheme was used to compute reference solutions for all 1-D examples in this study. The first-order scheme used for generating the inputs was equation 6. The time step size for the first order scheme was fixed during the evolution in time, e.g., Δt for the 50-cell grid and ½Δt for the 100-cell grid, satisfying the Courant-Friedrichs-Lewy (CFL) condition. To solve for equation 1, the first order leapfrog and diffusion splitting scheme used was per Equation 6 where α=Δx.

$$\{ \begin{matrix}\frac{{\overline{U}}_{i} - {U}_{i}^{n - 1}}{2 Δ t} + \frac{{f ( U ) {\vert}_{i + 1}^{n} - f ( U ) \vert}_{i - 1}^{n}}{2 Δ x} = 0 , \\ \frac{{U}_{i}^{n + 1} - {\overline{U}}_{i}}{Δ t} - α \frac{{\overline{U}}_{i + 1} - 2 \cdot {\overline{U}}_{i} + {\overline{U}}_{i + 1}}{Δ {x}^{2}} = 0 ,\end{matrix} \qquad ( 6 )$$

FIG. 9 depicts the predicted density profiles of the Lax and Sod problems using three different types of training approaches.

The first training strategy was to use the input type of equation 4 with training data generated from perturbed Lax and Sod problems described above. The same spatial and temporal grid sizes were used when computing inputs for the two problems. FIGS. 9C and 9F show the predicted results. The second training strategy used was the input type of Equation 5 with training data generated from perturbed Lax and Sod problems as described above. Because the time step size was treated as part of the input, the same spatial grid sizes were used with different time step sizes when computing inputs for the two problems. FIGS. 9A and 9D show, respectively, the two different time step sizes helped the neural network switch between the two problems, and the prediction results were improved. In order to make a smoother transition in the training data, two evenly distributed intermediate time step sizes were introduced between the above two-time step sizes, and the corresponding input data for the two problems was computed. The predicted results are shown in FIGS. 9B and 9E.

### Example 3: Variant of 2-diffusion-Coefficient NN for the Euler equations

Instead of computing for the input on two grids, the study generated the input on a single grid but for two perturbed equations with two different diffusion coefficients. This is referred to as the 2-Diffusion-Coefficient Neural Network (2DCNN). The perturbed scalar conservation law can be written per Equation 7.

$$\frac{\partial U}{\partial t} + \frac{\partial f ( U )}{\partial x} = α \frac{{\partial }^{2} U}{\partial {x}^{2}} , x ∈ Ω ⊂ ℛ , t ∈ [ 0 , T ] \qquad ( 7 )$$

To fill the two parts of an input, the study computed Equation 7 with two different values of a using a low-cost scheme on a single grid. For example, the study can approximate Equation 7 using a Leapfrog and diffusion splitting scheme with α=Δx and cΔx per Equation Sets 8 and 9.

$$\{ \begin{matrix}\frac{{\overline{U}}_{i} - {U}_{i}^{n - 1}}{2 Δ t} + \frac{{f ( U ) {\vert}_{i + 1}^{n} - f ( U ) \vert}_{i - 1}^{n}}{2 Δ x} = 0 , \\ \frac{{U}_{i}^{n + 1} - {\overline{U}}_{i}}{Δ t} - Δ x \frac{{\overline{U}}_{i + 1} - 2 \cdot {\overline{U}}_{i} + {\overline{U}}_{i - 1}}{Δ {x}^{2}} = 0 ,\end{matrix} \qquad ( Eq . Set 8 )$$

$$\{ \begin{matrix}\frac{{\overline{V}}_{i} - {V}_{i}^{n - 1}}{2 Δ t} + \frac{{f ( V ) {\vert}_{i + 1}^{n} - f ( V ) \vert}_{i - 1}^{n}}{2 Δ x} = 0 , \\ \frac{{V}_{i}^{n + 1} - {\overline{V}}_{i}}{Δ t} - c Δ x \frac{{\overline{V}}_{i + 1} - 2 \cdot {\overline{V}}_{i} + {\overline{V}}_{i - 1}}{Δ {x}^{2}} = 0.\end{matrix} \qquad ( Eq . Set 9 )$$

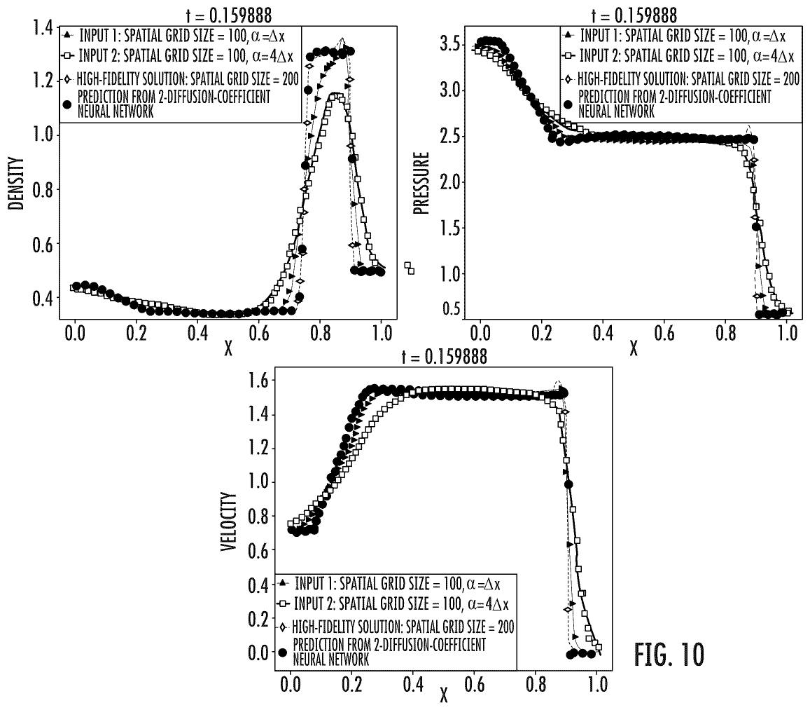

Then the input computed on a single uniform grid can be written as {Uᵢ₋₁ⁿ⁻¹, Uᵢⁿ⁻¹, Uᵢ₊₁ⁿ⁻¹, Uᵢⁿ, Vᵢ₋₁ⁿ⁻¹, Vᵢⁿ⁻¹, Vᵢ₊₁ⁿ⁻¹, Vᵢⁿ}. Similarly for the Euler system, FIG. 10 shows the predictions by 2DCNN, with the input computed on a uniform grid with 100 cells and c=4. For the second equation of (9), the larger diffusion coefficient may require a timestep size smaller than that of the first Equation of 9. Therefore, the study computed the second equation of the Equation Set 9 in two time steps, with the timestep size ½Δt for each time step. It is contemplated that the 2DCNN as shown in this study may be extended to high dimensions, such as in two dimensional systems.

### Example #2 The Woodward-Colella Problem

Variant of 2-Coarse grid NN for the Woodward-Colella Problem

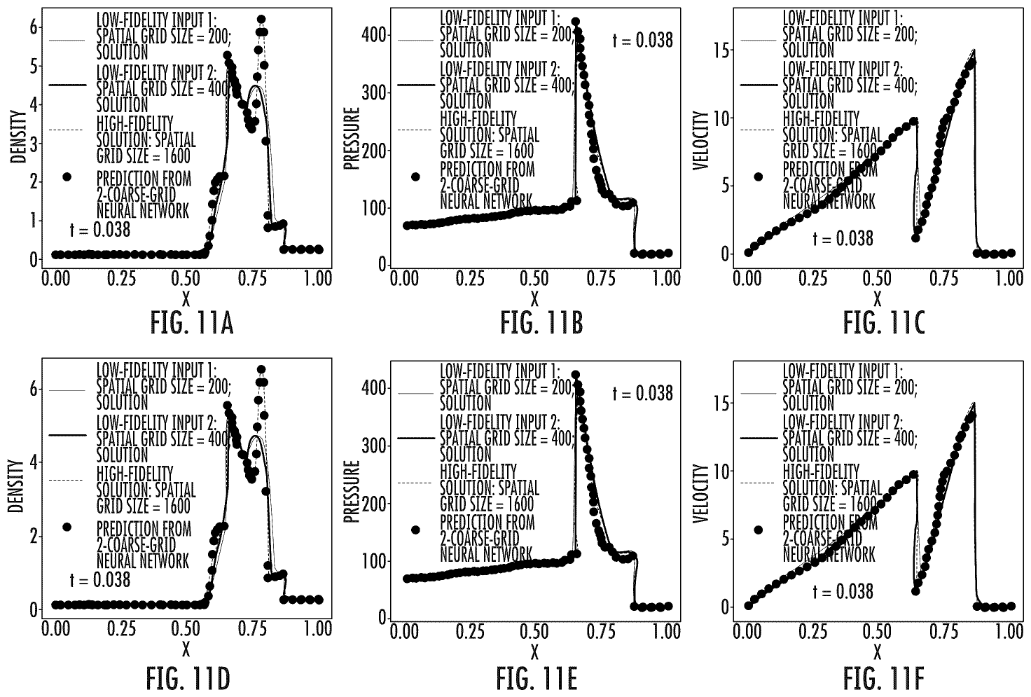

In the previous study (Example #1), the low-cost schemes used were all first-order schemes. These schemes may not work well for computing inputs for 2CGNN for the Woodward-Colella (W-C) problem [32], because, on reasonable grid sizes, these inputs are too qualitatively different from the solution. Therefore, a 3^{rd} order finite volume scheme was used for computing reference solutions to compute inputs on grids with 200 and 400 cells for 2CGNN with the input type of equation 4. FIGS. 11A-11F show the interactive blast waves of the W-C problem predicted by 2CGNN. It may be considered that the predictions provide a high-fidelity solution to the Woodward-Colella problem. The training of the neural network was similar to that in Example #1.

Variant of 2-Diffusion-Coefficient NN for the Woodward-Colella Problem. Instead of computing for the input on two grids, the input was generated on a single grid but for two perturbed equations with two different diffusion coefficients. This is referred to as the 2-Diffusion-Coefficient Neural Network (2DCNN.)

In this study, an exemplary 2-Diffusion-Coefficient Neural Network (2DCNN) for solving 1-D Riemann problems is tested. The low-cost scheme used is a first-order scheme (leapfrog and diffusion splitting scheme), with different diffusion coefficients for computing low-fidelity solutions as inputs for the Lax and Sod problems. However, first-order schemes do not work well for computing inputs for 2CGNN for the Woodward-Colella problem, as mentioned previously. Therefore, the first-order Rusanov scheme was used and the 3^{rd} order finite volume scheme for reference solutions was used to compute inputs on the same coarse grid.

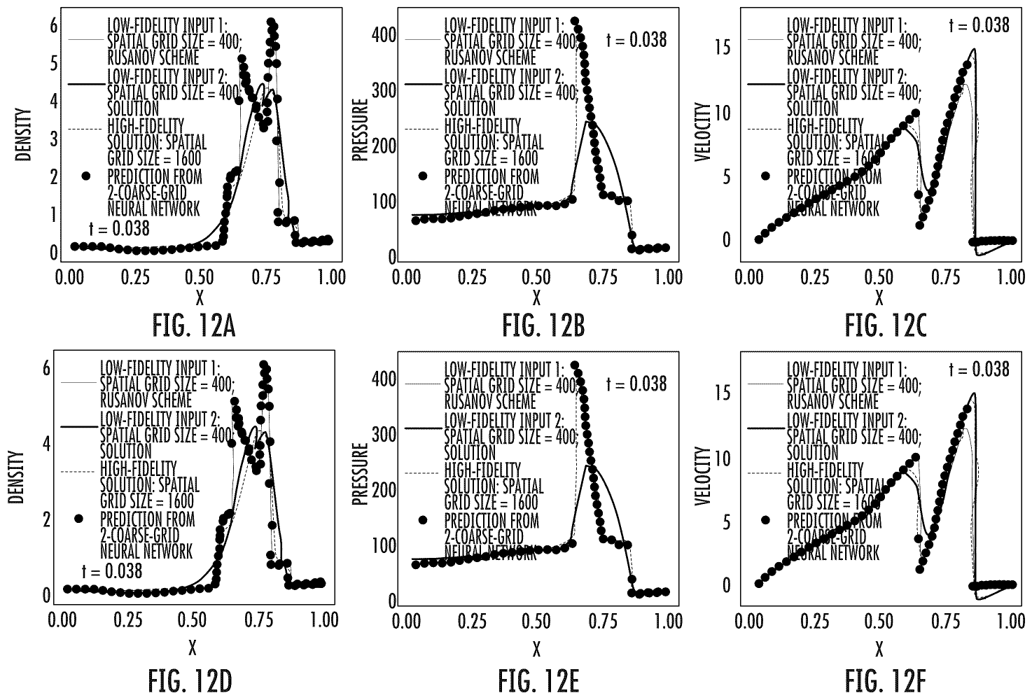

This process can be viewed as a variant of 2DCNN because only one grid is used in computing inputs. The input format is similar to equation 4, with the first part of the input computed by the Rusanov scheme at corresponding space-time locations and the second part of the input computed by the higher order scheme at the same space-time locations. FIGS. 12A-12F show the interactive blast waves of the W-C problem predicted by 2DCNN. It may be considered that the predictions provide a high-fidelity solution to the Woodward-Colella problem. The training of the neural network is similar to that in Example #1.

### Example #3 Euler Equations in 2-D Using 2CGNN

In one study, 2-coarse-grid neural networks were extended from one-dimensional problems to two dimensional problems. The 2D scalar conservation law was considered per Equation 10A together with the 2D Euler equations for the ideal gas per Equation 10B.

$$\frac{\partial U}{\partial t} + \frac{\partial f ( U )}{\partial x} + \frac{\partial g ( U )}{\partial y} = 0 , x , y ∈ Ω ⊂ ℛ , t ∈ [ 0 , T ] , \qquad ( 10 A )$$

$$\frac{\partial }{\partial t} ( \begin{matrix}ρ \\ ρ u \\ ρ v \\ E\end{matrix} ) + \frac{\partial }{\partial x} ( \begin{matrix}ρ u \\ ρ {u}^{2} + p \\ ρ uv \\ u ( E + p )\end{matrix} ) + \frac{\partial }{\partial y} ( \begin{matrix}ρ v \\ ρ vu \\ ρ {v}^{2} + p \\ v ( E + p )\end{matrix} ) = 0 , x , y ∈ Ω ⊂ ℛ , t ∈ [ 0 , T ] , \qquad ( 10 B )$$

In Equations 10A and 10B, p, u, v and p are density, x and y components of velocity, and pressure, respectively, where

$$E = \frac{p}{γ - 1} + \frac{1}{2} ρ ( {u}^{2} + {v}^{2} ) ,$$

and γ=1.4.

Input, Output and Loss Function. In the study, a grid of Ω=[a, b]×[c, d] was partitioned with the coarsest uniform rectangular grid α=x₀<x₁< . . . <x_{M}=b and c=y₀<y₁<<y_{N}=d. The spatial grid size was Δx=x₁−x₀ and Δy=y₁−y₀, and the time step size was Δt. The grid was refined to obtain a finer uniform grid with spatial grid size ½Δx and ½Δy, and timestep size ½Δt. A low-cost scheme, L, is used to compute equation 10 on both grids. It was contemplated that the predicted solution at (x, y, t), which was referred as (i′, j′, n′) in the coarsest grid, was chosen to be the coarsest grid solution (computed by L) at 9 points (x_{i′-1}, y_{j′-1}), (x_{i′-1}, y_{j′}), (x_{i′-1}, y_{j′+1}), (x_{i′}, y_{j′-1}), (x_{i′}, y_{j′}), (x_{i′}, y_{j′+1}), (x_{i′+1}, y_{j′-1}), (x_{i′+1}, y_{j′}), and (x_{i′+1}, y_{j′+1}) at time level t_{n′}−1, and also at point (x_{i′}, y_{i′}, t_{n′}) as the first part of the input of the neural network, and the finer grid solution (also computed by L) at the same space-time locations as the second part of input. The chosen 10 space-time locations on both grids enclosed a local (space-time) domain of dependence of the exact solution at (x_{i′}, y_{i′}, t_{n′}) (with Δt satisfying the CFL condition.)

The first part of the 2D input was denoted as

w_{i′-1,j′-1}^{n′-1},w_{i′-1,j′}^{n′-1},w_{i′-1,j′+1}^{n′-1},w_{i′,j′-1}^{n′-1},w_{i′,j′}^{n′-1},w_{i′+1,j′+1}^{n′-1},w_{i′+1,j′-1}^{n′-1},w_{i′+1,j′}^{n′-1},w_{i′+1,j′+1}^{n′-1},w_{i′,j′}^{n′},

and the second part of the 2D input as

w_{i″-2,j″-2}^{n″-2},w_{i″-2,j″}^{n″-2},w_{i″-2,j″+2}^{n″-2},w_{i″,j″-2}^{n″-2},w_{i″,j″}^{n″-2},w_{i″,j″+2}^{n″-2},w_{i″+2,j″-2}^{n″-2},w_{i″+2,j″}^{n″-2}, w_{i″+2,j″+2}^{n″-2},w_{i″,j″}^{n″}.

The space-time indices (i′, j′, n′) on the coarsest grid referred to the same location as (i″, j″, n″) did on the finer grid, and (i′−1, j′−1, n′−1) refers to the same location as (i″−2, j″−2, n″−2) did, and so on. The input of 2CGNN being:

{w_{i′-1,j′-1}^{n′-1},w_{i′-1,j′}^{n′-1},w_{i′-1,j′+1}^{n′-1},w_{i′,j′-1}^{n′-1},w_{i′,j′}^{n′-1},w_{i′+1,j′+1}^{n′-1},w_{i′+1,j′-1}^{n′-1},w_{i′+1,j′}^{n′-1},w_{i′+1,j′+1}^{n′-1}, w_{i′,j′}^{n′},w_{i″-2,j″-2}^{n″-2},w_{i″-2,j″}^{n″-2},w_{i″-2,j″+2}^{n″-2},w_{i″,j″-2}^{n″-2},w_{i″,j″}^{n″-2},w_{i″,j″+2}^{n″-2},w_{i″+2,j″-2}^{n″-2},w_{i″+2,j″}^{n″-2}, w_{i″+2,j″+2}^{n″-2},w_{i″,j″}^{n″}}.

called the “input of w,” and the corresponding output of 2CGNN was the predicted solution of equation B7 at (x, y, t) (or (i′, j′, n′) on the coarsest grid. For the Euler system, the input and output of 2CGNN were made up of corresponding ones for each prime variable. For example, the input was the vector {input of p, input of u, input of v, input of p} with 20×4=80 elements, and the corresponding output was {p, u, v, p} at (x, y, t) (or (i′, j′, n′) on the coarsest grid) with 4 elements. The loss function measured the difference between the output and the reference solution corresponding to the input, and was defined as follows:

Loss=Σₖ∥(output corresponding to k^{th} set of input)−(reference solution corresponding to k^{th} set of input)∥₂²,

where the summation went through every set of input in the training data. The training of the neural network is similar to that in Example #1.a

Generation of Input and Training Data. The study used the 2CGNN scheme to predict solutions of Riemann problems in two dimensions for an exemplified polyprotic gas. For the exemplified gas, labeled Configuration 6, the corresponding neural network included 8 hidden layers. The activation function used was “tanh.” The exemplified polyprotic gas, Configuration 6, was retrieved from P. Lax, X. Liu, “Solution of two-dimensional Riemann problems of gas dynamics by positive schemes,” SIAM Journal on Scientific Computing 19 (2) (1998) 319-340, which is incorporated herein, in its entirety.

During the training process, the neural network minimized the difference between outputs and a reference solution by first using an Adam optimizer and then using an L-BFGS optimizer in TensorFLow (with the number of iterations per optimization procedure under 50000 each.)

After the training was completed, the neural network was used to predict a solution (different from the training data), given an input computed by the same low-cost scheme(s) and grids that were used to compute the inputs of the training data. Here, the trained neural network was used to predict final solutions for 5 initial values of the Euler system for each configuration, including the original initial value of the configuration and +3% and ±5% perturbations of the initial value.

A first-order scheme on the coarsest uniform grid (200 cells in each spatial dimension) and the finer uniform grid (400 cells each spatial dimension) was used to generate the training data and to compute the input data from several initial values of the Euler system for each configuration, including ±2%, ±4%, ±6%, ±8% and +10% perturbations of the initial value of the configuration. The high-resolution reference solutions of the training data were computed on a uniform grid with 400 cells in each spatial dimension (note that solution values at grid points needed to be interpolated from cell averages.) A 4^{th}-order central scheme on overlapping cells with HR limiting [9] was used for computing reference solutions for all 2D Riemann problems. The low-cost scheme for Equation 7 used for computing inputs was the first-order leapfrog and diffusion splitting scheme per Equation 11.

$$\{ \begin{matrix}\frac{{\overline{U}}_{i , j} - {U}_{i , j}^{n - 1}}{2 Δ t} + \frac{{f ( U ) {\vert}_{i + 1 , j}^{n} - f ( U ) \vert}_{i - 1 , j}^{n}}{2 Δ x} + \frac{{g ( U ) {\vert}_{i , j + 1}^{n} - g ( U ) \vert}_{i , j - 1}^{n}}{2 Δ y} = 0 , \\ \frac{{U}_{i , j}^{n + 1} - {\overline{U}}_{i , j}}{Δ t} - α [ \frac{{\overline{U}}_{i + 1 , j} - 2 \cdot {\overline{U}}_{i , j} + {\overline{U}}_{i - 1 , j}}{Δ {x}^{2}} + \frac{{\overline{U}}_{i , j + 1} - 2 \cdot {\overline{U}}_{i , j} + {\overline{U}}_{i , j - 1}}{Δ {y}^{2}} ] = 0 ,\end{matrix} \qquad ( 11 )$$

In Equation 11, a=Δx, and Δx=Δy throughout the examples. The time step size for the first order scheme is fixed during the evolution in time, e.g., Δt for the 200×200 grid and ½Δt. For the 400×400 grid, satisfying the CFL condition.

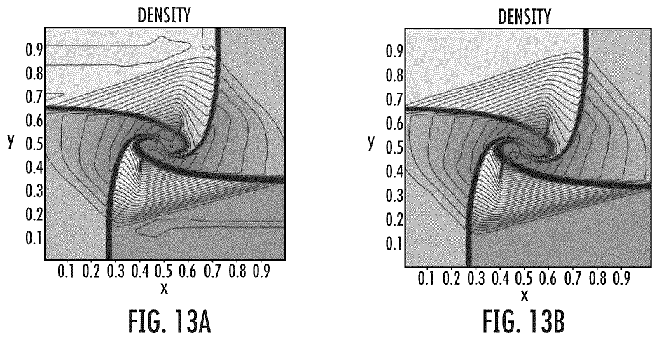

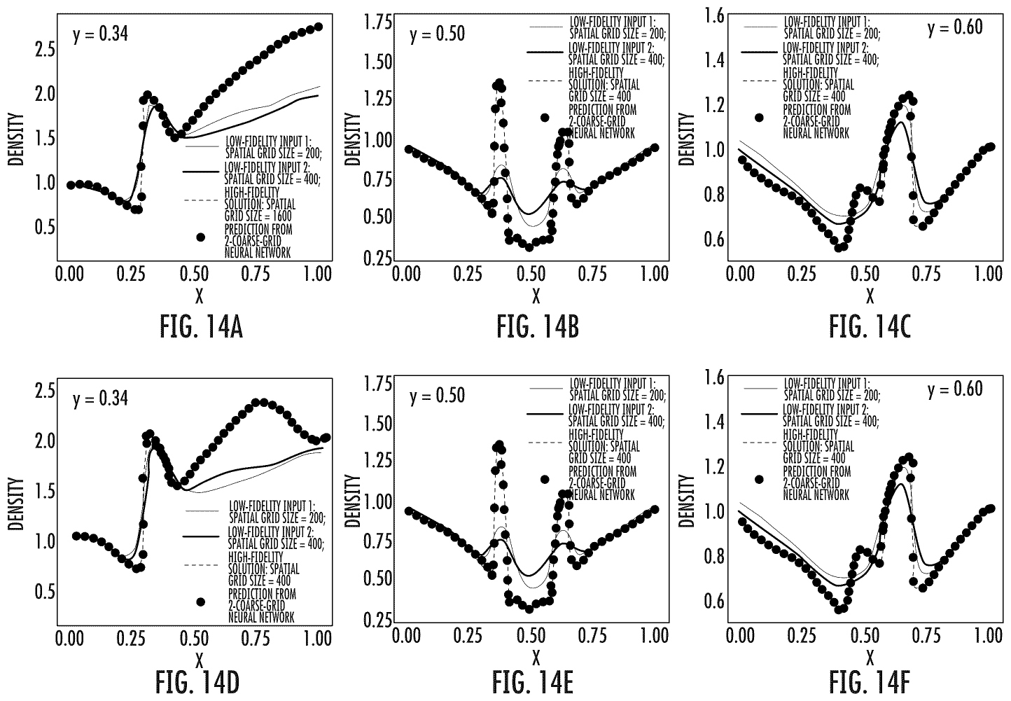

Results and Discussion for 2D Riemann Problems. The algorithm 2CGNN was used with inputs computed by the first-order leapfrog and diffusion splitting scheme to predict most of the problems. FIGS. 13A-B and FIGS. 14A-14F show the predictions of the final-time solutions of the 2D Riemann problems. The predicted solution profiles of cross sections perpendicular to the y-axis at the final time capture shocks and contacts, as well as the smooth regions of the solution, accurately. The spatial computational domain was [0, 1]×[0, 1] unless otherwise specified.

FIG. 13A shows the predicted final-time solution of the 2D Euler system in Configuration 6. The corresponding density cross sections perpendicular to the y-axis of configuration 6 at y=0.34, y=0.50, y=0.60, y=0.70, and y=0.80 are shown in FIGS. 14A-14C. FIG. 13B shows the prediction of the final-time solution of the 2-D Euler system, with the initial value being +5% perturbation of that of Configuration 6, and FIGS. 14D-14F show the density cross-section profiles perpendicular to the y-axis at the locations of the original initial values case.

Since the coarsest grid for input had 200 grid cells, the spatial grid for the predicted solution also has 200 grid cells. The predictions do not depict smeared solutions like their low-cost input solutions. Note that the configuration cases for predictions were not included in the training data.

### Example #4 Euler Equations in 2-D Using 2DCNN

The study considered another set of equations for exemplified polyprotic gas. The system included composition 8, equation 7, which can be approximated using the leapfrog and diffusion splitting scheme of equation 11 with α=Δx and cΔx per Equations 12 and 13.

$$\{ \begin{matrix}\frac{{\overline{U}}_{i , j} - {U}_{i , j}^{n - 1}}{2 Δ t} + \frac{{f ( U ) {\vert}_{i + 1 , j}^{n} - f ( U ) \vert}_{i - 1 , j}^{n}}{2 Δ x} + \frac{{g ( U ) {\vert}_{i , j + 1}^{n} - g ( U ) \vert}_{i , j - 1}^{n}}{2 Δ y} = 0 , \\ \frac{{U}_{i , j}^{n + 1} - {\overline{U}}_{i , j}}{Δ t} - Δ x [ \frac{{\overline{U}}_{i + 1 , j} - 2 \cdot {\overline{U}}_{i , j} + {\overline{U}}_{i - 1 , j}}{Δ {x}^{2}} + \frac{{\overline{U}}_{i , j + 1} - 2 \cdot {\overline{U}}_{i , j} + {\overline{U}}_{i , j - 1}}{Δ {y}^{2}} ] = 0 ,\end{matrix} \qquad ( 12 )$$

$$\{ \begin{matrix}\frac{{\overline{V}}_{i , j} - {V}_{i , j}^{n - 1}}{2 Δ t} + \frac{{f ( V ) {\vert}_{i + 1 , j}^{n} - f ( V ) \vert}_{i - 1 , j}^{n}}{2 Δ x} + \frac{{g ( V ) {\vert}_{i , j + 1}^{n} - g ( V ) \vert}_{i , j - 1}^{n}}{2 Δ y} = 0 , \\ \frac{{V}_{i , j}^{n + 1} - {\overline{V}}_{i , j}}{Δ t} - c Δ x [ \frac{{\overline{V}}_{i + 1 , j} - 2 \cdot {\overline{V}}_{i , j} + {\overline{V}}_{i - 1 , j}}{Δ {x}^{2}} + \frac{{\overline{V}}_{i , j + 1} - 2 \cdot {\overline{V}}_{i , j} + {\overline{V}}_{i , j - 1}}{Δ {y}^{2}} ] = 0.\end{matrix} \qquad ( 13 )$$

Then the input computed on a single uniform grid can be written as:

{U_{i-1,j-1}ⁿ⁻¹,U_{i-1,j}ⁿ⁻¹,U_{i-1,j+1}ⁿ⁻¹,U_{i,j-1}ⁿ⁻¹,U_{i,j}ⁿ⁻¹,U_{i,j+1}ⁿ⁻¹,U_{i+1,j-1}ⁿ⁻¹,U_{i+1,j}ⁿ⁻¹,U_{i+1,j+1}ⁿ⁻¹,U_{i,j}ⁿ,V_{i-1,j-1}ⁿ⁻¹,V_{i-1,j}ⁿ⁻¹, V_{i-1,j+1}ⁿ⁻¹,V_{i,j-1}ⁿ⁻¹,V_{i,j}ⁿ⁻¹,V_{i,j+1}ⁿ⁻¹,V_{i+1,j-1}ⁿ⁻¹,V_{i+1,j}ⁿ⁻¹,V_{i+1,j+1}ⁿ⁻¹,V_{i,j}ⁿ}.

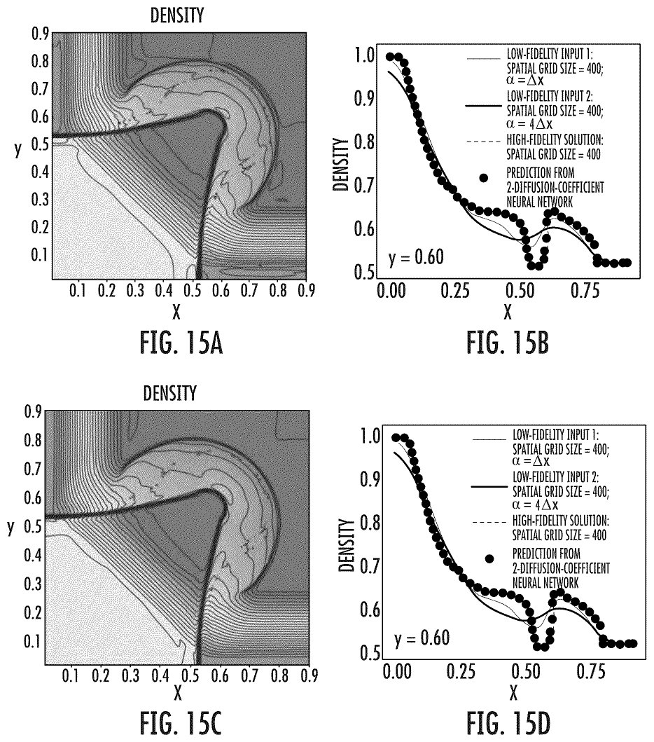

as the Euler system. FIGS. 15A-15D show the predictions by 2DCNN, and their cross-section profiles, with the input computed on a 400×400 uniform grid and c=4. For equation 13, the larger diffusion coefficient may require a smaller time step size than that of the first equation of (12). In that case, the second equation of (13) will be computed in two-time 1 steps, with the time step size ½Δt for each time step.

### Example #5: Airfoil or Aircraft Shape Optimization

The study evaluated the exemplary method and system integrated into a software package for computing high-fidelity aerodynamics around an object. The system used two low-cost software packages for computing aerodynamics around the object (the result from one package is closer to the high-fidelity solution than that from the other). The two low-cost software packages can be obtained by applying the first software package on two coarse grids (thus with low costs.)

The study evaluated a scenario in which there are a lot of designs that need to be simulated around. The study can first pick several characteristic designs and use all 3 software packages to run simulations around them to generate inputs and corresponding high-fidelity solutions. The data is used for training a neural network of the exemplary system and method. Then for the remaining designs (which are the majority), the study could simply use the two low-cost software packages to run two low-cost simulations, then use the trained neural network to scan through the two solutions (using two local moving patches as the input) to update the solutions to a high-fidelity solution. The exemplary system and method can reduce the tremendous amount of computational cost by running high-fidelity simulations only on several designs instead of all possible design variations.

### Example #6: Antenna and Scattering Object Designs

The study contemplated evaluating the exemplary method and system implemented as a software package for computing the high-fidelity electromagnetic wave around an object and two low-cost software packages for computing the electromagnetic wave around the object (the result from one package is closer to the high-fidelity solution than that from the other). The two low-cost software packages can be obtained by applying the first software package on two coarse grids (thus with low costs.) The exemplary system and method can reduce the computational cost for various scattering object designs, similar to example #5.

### Example #7: Engine Chamber Designs

The study contemplated evaluating the exemplary method and system implemented as a software package for computing the combustion fluids inside an engine chamber and two low-cost software packages for computing the combustion fluids inside the engine chamber (the result from one package is closer to the high-fidelity solution than that from the other). The two low-cost software packages can be obtained by applying the first software package on two coarse grids (thus with low costs.) The exemplary system and method can reduce the computational cost for various chamber designs, similar to Example #5.

### Example #8: Structure Designs

The study contemplated evaluating the exemplary method and system implemented as a finite element software package for computing the forces inside a structure and two low-cost software packages for computing the forces inside the structure (the result from one package is closer to the high-fidelity solution than that from the other). The two low-cost software packages can be obtained by applying the first software package on two coarse grids (thus with low costs.)

The exemplary system and method can reduce the computational cost for various structure designs, similar to Example #5.

Further descriptions of the exemplary system and method are provided in Haoxiang Huang, Yingjie Liu, and Vigor Yang, “Neural Networks with Inputs Based on Domain of Dependence and A Converging Sequence for Solving Conservation Laws, Part I: 1D Riemann Problems”, 20 Sep. 2021, arXiv:2109.09316v1. and Haoxiang Huang, Yingjie Liu, and Vigor Yang, “Neural Networks with Local Converging Inputs (NNLCI) for Solving Conservation Laws, Part II: 2D Problems”, 21 Apr. 2022, arXiv:2204.10424v1, each of which is hereby incorporated by reference herein in its entirety.

### DISCUSSION

There has been a lot of research work on numerical methods for solving conservation laws whose solutions may contain shocks and contact discontinuities, such as the Godunov scheme [1], MUSCL scheme [2, 3], ENO [4, 5] and WENO [6, 7] schemes, hierarchical reconstruction [8, 9, 10], and many others. Numerical techniques are important for studying high-speed aerodynamic flows, which play a substantial role in aircraft designs, combustion problems, and astronomy physics [11, 12, 13, 14]. However, the development of machine learning techniques for solving hyperbolic conservation laws is still in the early stage.

In the past decade, data-driven modeling in machine learning has been widely developed for multiple scientific disciplines, including image processing, biomedical applications, and engineering design optimization [15, 16, 17, 18, 19, 20, 21]. Especially, advances in computational resources, e.g. graphics processing unit (GPU) and tensor processing unit (TPU), accelerate training speed in deep learning frameworks, e.g. TensorFlow, PyTorch, for computer vision, natural language processing and other important scientific disciplines [22, 23, 24].

In two published models [25], [26], low-cost numerical solutions are used as the input of a neural network to predict a high-fidelity solution. The shortcomings of these models to the exemplary system and method are: (a) only one low-cost solution is used as input, and the exemplary system and method, two low-cost solutions from a converging sequence are used as the input. (b) The published models of [25], [26] are non-local; that is, the neural network maps a patch of the low-cost solution to a patch of about the same size as the high-fidelity solution; the neural network of the exemplary system and method are local, which maps a small local patch of two low-cost solutions to the high-fidelity solution at a space-time point. All other neural networks for solving differential equations are completely different in the input format from the exemplary system and method.

There are other publications [27], [28] relating to or using neural networks for models relating to multi-resolution inputs in image/data processing. They are NOT designed to solve differential equations. Their inputs are NOT local low-cost numerical solutions of a differential equation, and their outputs are NOT the solution of a differential equation at a space-time point. For example, the metric can be evaluated using machine learning and artificial intelligence operation.

The exemplary system and method can be used in numerous industrial design/optimization software, AI chips by RD departments, research institutes, etc., and can become a key factor in deciding when to use low computational complexity and high-fidelity results. There are no limits to the practical applications of the exemplary method and system where high-fidelity numerical solutions can be made available for a small number of test cases to train the neural network and where two low-cost numerical solutions in a converging sequence can be provided as inputs to the neural network. In some uses, the low-cost numerical solutions can be obtained using a high-fidelity numerical method run on coarse grids.

Additional Discussion

As discussed above, industrial design and optimization often involve intensive computer simulations of underlying differential equations, for example, in airfoil design, car shape optimization, engine design, building design, etc. The simulation can take days or even weeks for each design, and the optimal design will be chosen after simulations for all possible designs have been conducted. Prior arts tried to use neural networks to reduce the simulation cost by first running a coarse grid simulation with low cost, then using a trained neural network to update the coarse-grid solution to a high-fidelity solution. Since the neural network takes the whole coarse-grid simulation result or a large patch of it as input to predict a high-fidelity solution on the same large area, the neural network must be very large, and the training of it will be difficult and costly. And it cannot do well in predicting solutions containing discontinuities.

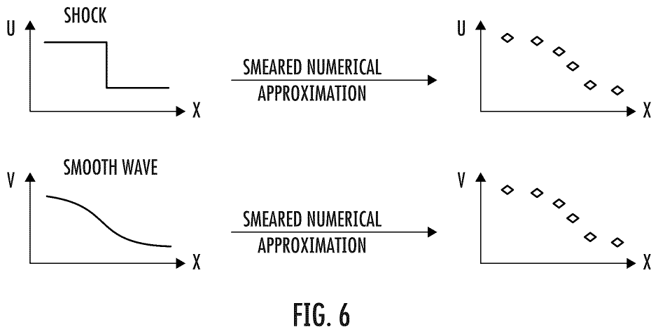

To overcome the problems, one could consider a local version by taking a small patch of the coarse-grid simulation result as the input of a neural network in order to predict the high-fidelity solutions at the center of the small patch. However, the small patch of the coarse-grid simulation result does not contain a sufficient amount of information to predict the high-fidelity solution at the center of the small patch. For example, as shown in FIG. 6, a small patch of the coarse-grid solution of a shock wave will be very smeared and looks very similar to a small patch of the coarse-grid solution of a smooth wave. A neural network taking them as inputs has no way to tell the difference between them and therefore is not able to predict the high-fidelity solutions corresponding to them. The exemplary method and system performs two or more low-cost simulations first so that one simulation result is closer to the high-fidelity solution than the other. To predict the high-fidelity solution at a space-time location, the neural network can take two corresponding small patches as its input from the two low-cost simulation results, respectively.

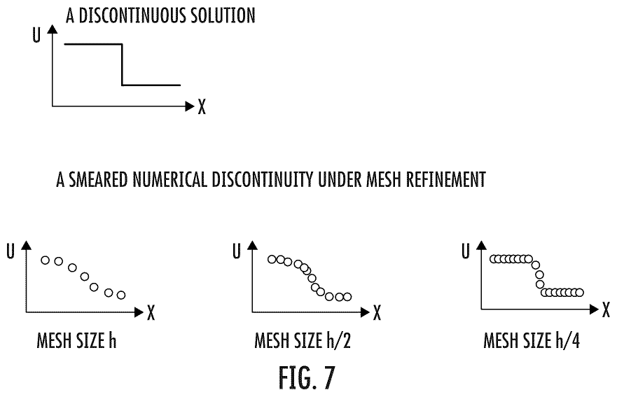

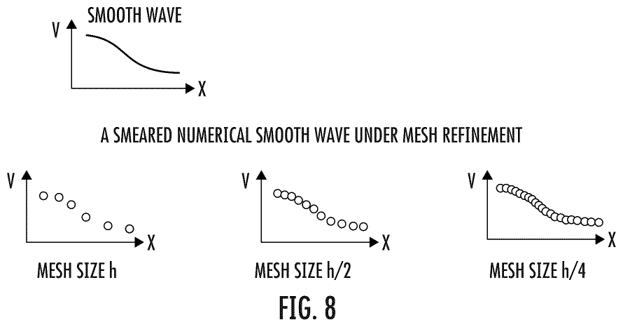

If a shock wave is contained in the two patches, for example as shown in FIG. 7, it will look steeper in one patch than in the other because one simulation result is closer to the high-fidelity solution than the other. On the other hand, if a smooth wave is contained in the two patches, it will look similar in both patches, for example as shown in FIG. 8. Therefore, the neural network is able to tell the difference between them and make accurate predictions accordingly. The neural network not only predicts shock waves and other discontinuities in the 30olution but also predicts the smooth part of the solution accurately. Therefore, the exemplary system and method can be used in all kinds of simulations. When it's impossible to take two small local patches from two low-cost simulations to fit the given format of the input because of grid irregularities, one can first interpolate the low-cost simulations to a uniform rectangular grid and then take two small local patches from the rectangular grid.

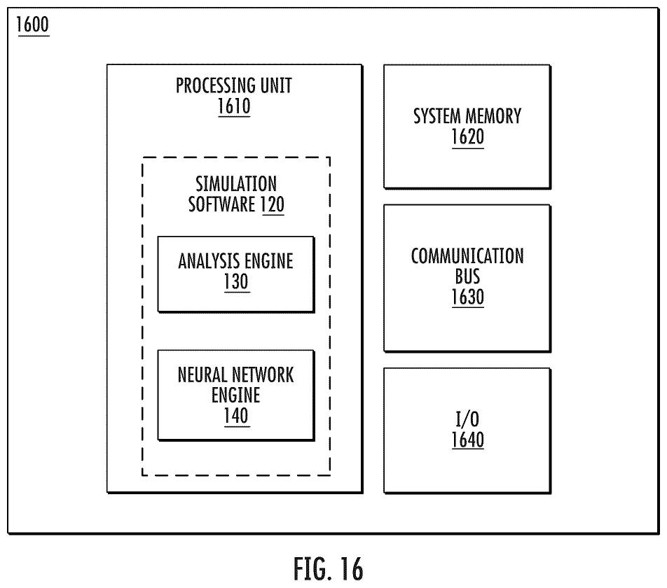

Example Computing System. The exemplary system and method may be implemented (1) as a sequence of computer-implemented acts or program modules running on a computing system and/or (2) as interconnected machine logic circuits or circuit modules within the computing system (FIG. 16). The implementation is a matter of choice dependent on the performance and other requirements of the computing system. Accordingly, the logical operations described herein are referred to variously as state operations, acts, or modules. These operations, acts, and/or modules can be implemented in software, in firmware, in special purpose digital logic, in hardware, and any combination thereof. It should also be appreciated that more or fewer operations can be performed than shown in the figures and described herein. These operations can also be performed in a different order than those described herein.

The computer system is capable of executing the software components described herein for the exemplary method or systems. In an embodiment, the computing device may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computing device to provide the functionality of a number of servers that are not directly bound to the number of computers in the computing device. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or can be hired on an as-needed basis from a third-party provider. Some cloud computing environments may comprise cloud computing resources owned and operated by the enterprise as well as cloud computing resources hired and/or leased from a third-party provider.

In its most basic configuration, a computing device includes at least one processing unit 1610 and system memory 1620, as shown in FIG. 16. Depending on the exact configuration and type of computing device, system memory may be volatile (such as random-access memory (RAM)), non-volatile (such as read-only memory (ROM), flash memory, etc.), or some combination of the two.

The processing unit may be a standard programmable processor that performs arithmetic and logic operations necessary for the operation of the computing device. While only one processing unit is shown, multiple processors may be present. As used herein, processing unit and processor refers to a physical hardware device that executes encoded instructions for performing functions on inputs and creating outputs, including, for example, but not limited to, microprocessors (MCUs), microcontrollers, graphical processing units (GPUs), and application-specific circuits (ASICs). Thus, while instructions may be discussed as executed by a processor, the instructions may be executed simultaneously, serially, or otherwise executed by one or multiple processors. The computing device may also include a bus or other communication mechanism 1630 for communicating information among various components of the computing device.

Computing devices may have additional features/functionality. For example, the computing device may include additional storage such as removable storage and non-removable storage including, but not limited to, magnetic or optical disks or tapes. Computing devices may also contain network connection(s) that allow the device to communicate with other devices, such as over the communication pathways described herein. The network connection(s) may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. Computing devices may also have input device(s) 1640 such as keyboards, keypads, switches, dials, mice, trackballs, touch screens, voice recognizers, card readers, paper tape readers, or other well-known input devices. Output device(s) 1640 such as printers, video monitors, liquid crystal displays (LCDs), touch screen displays, displays, speakers, etc., may also be included. The additional devices may be connected to the bus in order to facilitate the communication of data among the components of the computing device. All these devices are well known in the art and need not be discussed at length here.

The processing unit may be configured to execute program code encoded in tangible, computer-readable media. Tangible, computer-readable media refers to any media that is capable of providing data that causes the computing device (i.e., a machine) to operate in a particular fashion. Various computer-readable media may be utilized to provide instructions to the processing unit for execution. Example tangible, computer-readable media may include but is not limited to volatile media, non-volatile media, removable media, and non-removable media implemented in any method or technology for storage of information such as computer-readable instructions, data structures, program modules, or other data. System memory, removable storage, and non-removable storage are all examples of tangible computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In light of the above, it should be appreciated that many types of physical transformations take place in the computer architecture to store and execute the software components presented herein. It also should be appreciated that the computer architecture may include other types of computing devices, including hand-held computers, embedded computer systems, personal digital assistants, and other types of computing devices known to those skilled in the art.

In an example implementation, the processing unit may execute program code stored in the system memory. For example, the bus may carry data to the system memory, from which the processing unit receives and executes instructions. The data received by the system memory may optionally be stored on the removable storage or the non-removable storage before or after execution by the processing unit.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and it may be combined with hardware implementations.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used.

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications, and publications, as listed below and throughout this document, are hereby incorporated by reference in their entirety herein.

### REFERENCES

[1] S. K. Godunov, A difference scheme for numerical solution of discontinuous solution of hydrodynamic equations, Mat. Sb. 47 (1959) 271-306.
[2] B. van Leer, Towards the ultimate conservative difference scheme I, Lecture Notes in Phys. 18 (1973) 163-168.
[3] B. van Leer, Towards the ultimate conservative difference scheme v, a second-order sequel to godunov's method, J. Comput. Phys. 32 (1979) 101-136.
[4] A. Harten, B. Engquist, S. Osher, S. R. Chakravarthy, Uniformly high order accuracy essentially non-oscillatory schemes iii, J. Comput. Phys. 71 (2) (1987) 231-303.
[5] C.-W. Shu, S. Osher, Efficient implementation of essentially non-oscillatory shock-capturing schemes, J. Comput. Phys. 77 (1988) 439-471.
[6] X. D. Liu, S. Osher, T. Chan, Weighted essentially non-oscillatory schemes, J. Comput. Phys. 115 (1) (1994) 200-212.
[7] G.-S. Jiang, C.-W. Shu, Effcient implementation of weighted ENO schemes, J. Comput. Phys. 126 (1996) 202-228.
[8] Y. Liu, C.-W. Shu, E. Tadmor, M.-P. Zhang, Central discontinuous Galerkin methods on overlapping cells with a non-oscillatory hierarchical reconstruction, SIAM J. Num. Anal. 45 (2007) 2442-2467.
[9] Y. Liu, C.-W. Shu, E. Tadmor, M.-P. Zhang, Non-oscillatory hierarchical reconstruction for central and finite volume schemes, Communications in Computational Physics 2 (2007) 933-963.
[10] Z. Xu, Y. Liu, C.-W. Shu, Hierarchical reconstruction for discontinuous Galerkin methods on unstructured grids with a weno type linear reconstruction and partial neighboring cells, J. Comput. Phys. 228 (2009) 2194-2212.
[11] V. Yang, Modeling of supercritical vaporization, mixing, and combustion processes in liquid-fueled propulsion systems, Proceedings of the Combustion Institute 28 (1) (2000) 925-942.
[12] X. Wang, V. Yang, Supercritical mixing and combustion of liquid-oxygen/kerosene bi-swirl injectors, Journal of Propulsion and Power 33 (2) (2017) 316-322.
[13] U. Unnikrishnan, H. Huo, X. Wang, V. Yang, Subgrid scale modeling considerations for large eddy simulation of supercritical turbulent mixing and combustion, Physics of Fluids 33 (7) (2021) 075112.
[14] R. Teyssier, B. Commercon, Numerical methods for simulating star formation, Frontiers in Astronomy and Space Sciences 6 (2019) 51.
[15] A. Darcy, A. Louie, L. Roberts, Machine learning and the profession of medicine, JAMA 315 (6) (2016) 551-552.
[16] G. Karniadakis, I. Kevrekidis, L. Lu, P. Perdikaris, S. Wang, L. Yang, Physics-informed machine learning, Nature Reviews Physics 3 (2021) 422-440.
[17] B. Peherstorfer, K. Willcox, M. Gunzburger, Survey of multifidelity methods in uncertainty propagation, inference, and optimization, SIAM Review 60 (3) (2018) 550-591.
[18] A. Krizhevsky, I. Sutskever, G. Hinton, Imagenet classification with deep convolutional neural networks, Vol. 2, 2012, pp. 1097-1105, cited By 49543.
[19] Y. Chang, X. Wang, L. Zhang, Y. Li, S. Mak, C. Wu, V. Yang, Common kernel-smoothed proper orthogonal decomposition (ckspod): An efficient reduced-order model for emulation of spatiotemporally evolving flow dynamics (2021). arXiv:2101.08893.
[20] Y. Chang, L. Zhang, X. Wang, S. Yeh, S. Mak, C. Sung, C. Wu, V. Yang, Kernel-smoothed proper orthogonal decomposition{based emulation for spatiotemporally evolving ow dynamics prediction, AIAA Journal 57 (12) (2019) 5269-5280.
[21] S. Mak, C. Sung, X. Wang, S. Yeh, Y. Chang, V. Joseph, V. Yang, C. F. J. Wu, An efficient surrogate model for emulation and physics extraction of large eddy simulations, Journal of the American Statistical Association 113 (524) (2018) 1443-1456.
[22] S. Xin, S. Nousias, K. N. Kutulakos, A. C. Sankaranarayanan, S. G. Narasimhan, I. Gkioulekas, A theory of fermat paths for non-line-of-sight shape reconstruction, in: 2019 IEEE/CVF Conference on Computer Vision and Pattern Recognition (CVPR), 2019, pp. 6793-6802.
[23] A. Vaswani, N. Shazeer, N. Parmar, J. Uszkoreit, L. Jones, A. N. Gomez, L. Kaiser, I. Polosukhin, Attention is all you need, 2017.
[24] L. Chen, R. Paleja, M. Gombolay, Learning from suboptimal demonstration via self-supervised reward regression (2020). arXiv:2010.11723.
[25] D. Liu, Y. Wang, Multi-fidelity physics-constrained neural network and its application in materials modeling, J. Mech. Des. 141 (12) (2019) 121403.
[26] H. Nguyen, R. Tsai, Numerical wave propagation aided by deep learning (2021). arXiv:2107.13184.
[27] Yun Jiang, Chao Wu, Ge Wang, Hui-Xia Yao, Wen-Huan Liu, MFI-Net: A multi-resolution fusion input network for retinal vessel segmentation, PloS ONE 16(7): e0253056.
[28] T'oth, “Multi-resolution spectral input for convolutional neural network-based speech recognition,” 2017 International Conference on Speech Technology and Human-Computer Dialogue (SpeD), 2017, pp. 1-6, doi: 10.1109/SPED.2017.7990430.

What is claimed is:

1. A method comprising: in a simulation software,
(a) receiving, in an analysis engine of the simulation software, two numerical models for one or more differential equations to be evaluated by the simulation software, two or more numerical models including a first numerical model and a second numerical model, wherein the two or more numerical models are converging to an exact solution of the one or more differential equations;
(b) generating, by the analysis engine, from the first numerical model, a first numerical solution in a first grid patch in which the first grid patch corresponds to a local domain of dependence, and, wherein the first grid patch has a first grid resolution;
(c) generating, by the analysis engine, from the second numerical model, a second numerical solution in a second grid patch in which the second grid patch corresponds to the local domain of dependence, wherein the second grid patch has a second resolution that is different from the first grid patch; and
(d) generating a high-fidelity numerical solution value at a space-time location determined by the local domain of dependence for the system of partial differential equations using the trained neural network with its input generated in steps (b) and (c), and repeating steps (b) and (c) to provide as input to determine respective high-fidelity numerical solution values for one or more iteratively varying local domains of dependence
wherein a neural network is trained on one or more design iteration analyses of the plurality of design iteration analyses, wherein each of the one or more design iteration analyses includes (i) an exact or nearly exact solution to the one or more differential equations for the design iteration analysis and (ii) solutions to the two or more numerical models for the design iteration analysis.

2. The method of claim 1, wherein the neural network training comprises computing the difference between (i) the output of the neural network and (ii) the exact or nearly exact solution for use in a loss function.

3. The method of claim 1, further comprising:
repeating steps (b), (c), and (d) for an additional design iteration analysis of the plurality of design iteration analyses.

4. The method of claim 1, further comprising:
interpolating outputs of the two or more numerical models to align to common grid points of the first and second grid patches.

5. The method of claim 1, wherein the plurality of design iteration analyses correspond to an engineering model, scientific model, or financial model, wherein the two or more numerical models are used by the trained neural network to generate high-fidelity solutions for an additional design iteration analysis of the plurality of design iteration analyses.

6. The method of claim 1, wherein the trained neural network is a part of a neural network engine, the neural network engine comprising logic or instructions to direct steps (a)-(d).

7. The method of claim 6, wherein the neural network engine is executing on a cloud infrastructure.

8. The method of claim 6, wherein the neural network engine is executing on a computing device executing the analysis engine.

9. A system comprising:
one or more processors; and
a memory having instructions stored thereon, wherein the instructions, as part of a simulation software, when executed by a processor, cause the processor to perform the steps:
(a) receive, in an analysis engine of the simulation software, two numerical models for one or more differential equations to be analyzed or evaluated by the simulation software, including a first numerical model and a second numerical model, wherein the two or more numerical models are converging to an exact solution of the system of differential equations;
(b) generate, by the analysis engine, from the first numerical model, a first numerical solution in a first grid patch in which the first grid patch corresponds to a local domain of dependence, and, wherein the first grid patch has a first grid resolution;
(c) generate, by the analysis engine, from the second numerical model, a second numerical solution in a second grid patch in which the second grid patch corresponds to the local domain of dependence, wherein the second grid patch has a second resolution that is different from the first grid patch; and
(d) generate a high-fidelity numerical solution value at a space-time location determined by the local domain of dependence for the system of partial differential equations using the trained neural network with its input generated in steps (b) and (c), and repeat steps (b) and (c) to provide as input to determine respective high-fidelity numerical solution values for one or more iteratively varying local domains of dependence,
wherein a neural network is trained on one or more design iteration analyses of the plurality of design iteration analyses, wherein each of the one or more design iteration analyses includes (i) an exact or nearly exact solution to the system of differential equations for the design iteration analysis and (ii) solutions to the two or more numerical models for the design iteration analysis.

10. The system of claim 9, wherein the instructions further comprise the step:
repeat steps (b), (c), and (d) for an additional design iteration analysis of the plurality of design iteration analyses.

11. The system of claim 9, wherein the plurality of design iteration analyses corresponds to an engineering model, scientific model, or financial model, wherein the two or more numerical models are used by the trained neural network to generate high-fidelity solutions for an additional design iteration analysis of the plurality of design iteration analyses.

12. The system of claim 9, wherein the trained neural network is a part of a neural network engine, the neural network engine comprising logic or instructions to direct steps (a)-(d).

13. The system of claim 12, wherein the neural network engine is executed on a processor in a cloud infrastructure.

14. The system of claim 12, wherein the neural network engine and analysis engine are executed on one or more processors in a computing device.

15. A non-transitory computer-readable medium having instructions stored thereon, wherein the instructions, when executed by a processor, cause the processor to perform the steps:
(a) receive, in an analysis engine of a simulation software, two numerical models for one or more differential equations to be analyzed or evaluated by the simulation software, including a first numerical model and a second numerical model, wherein the two or more numerical models are converging to an exact solution of the one or more differential equations;
(b) generate, by the analysis engine, from the first numerical model, a first numerical solution in a first grid patch in which the first grid patch corresponds to a local domain of dependence, and, wherein the first grid patch has a first grid resolution;
(c) generate, by the analysis engine, from the second numerical model, a second numerical solution in a second grid patch in which the second grid patch corresponds to the local domain of dependence, wherein the second grid patch has a second resolution that is different from the first grid patch; and
(d) generate a high-fidelity numerical solution value at a space-time location determined by the local domain of dependence for the system of partial differential equations using the trained neural network with its input generated in steps (b) and (c), and repeat steps (b) and (c) to provide as input to determine respective high-fidelity numerical solution values for one or more iteratively varying local domains of dependence,
wherein a neural network is trained on one or more design iteration analyses of the plurality of design iteration analyses, wherein each of the one or more design iteration analyses includes (i) an exact or nearly exact solution to the one or more differential equations for the design iteration analysis and (ii) solutions to the two or more numerical models for the design iteration analysis.

16. The non-transitory computer-readable medium of claim 15, wherein the instructions further comprise the step:
repeat steps (b), (c), and (d) for an additional design iteration analysis of the plurality of design iteration analyses.

17. The non-transitory computer-readable medium of claim 15, wherein the plurality of design iteration analyses corresponds to an engineering model, scientific model, or financial model, wherein the two or more numerical models are used by the trained neural network to generate high-fidelity solutions for an additional design iteration analysis of the plurality of design iteration analyses.

18. The non-transitory computer-readable medium of claim 15, wherein the trained neural network is a part of a neural network engine, the neural network engine comprising logic or instructions to direct steps (a)-(d).

19. The non-transitory computer-readable medium of claim 15, wherein the neural network engine is implemented in a library file that can be coupled to the analysis engine.

20. The non-transitory computer-readable medium of claim 15, wherein the neural network engine is natively implemented in a simulation software comprising the analysis engine.
